(19) United States
(12) Patent Application Publication
(10) Pub. No.: US 2006/0042744 A1
(43) Pub. Date: Mar. 2, 2006

(54) Waterproofing execution method of three-plane crossing structure by means of extensible waterproofing and airtight pressure-sensitive adhesive sheet

(75) Inventors: Shouichi Yuumoto, Ibaraki-shi (JP); Masayuki Ishikawa, Ibaraki-shi (JP); Yasunori Hirose, Ibaraki-shi (JP); Shigenori Nagahama, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 11/210,783

(22) Filed: Aug. 25, 2005

(30) Foreign Application Priority Data
Aug. 31, 2004 (JP) P. 2004-251813

(51) Int. Cl. B32B 37/00; B32B 38/10

(52) U.S. Cl. 156/227; 156/247; 156/249

(57) ABSTRACT

A waterproofing execution method of a three-plane crossing structure by means of an extensible waterproofing and airtight pressure-sensitive adhesive sheet including sticking the extensible waterproofing and airtight pressure-sensitive adhesive sheet to a peripheral part of three-plane crossing including a point corner part which comes into contact with three planes in a three-plane crossing structure having the three planes wherein the three planes come into contact and respective planes of the three planes also come into contact with each other and peripheral parts thereof includes the processes (A) to (E) as described in the specification.

### FIELD OF THE INVENTION

The present invention relates to a waterproofing execution method of a three-plane crossing structure by means of an extensible waterproofing and airtight pressure-sensitive adhesive sheet. More specifically, it relates to a waterproofing execution method which is applied, by means of an extensible waterproofing and airtight pressure-sensitive adhesive sheet, to a peripheral part of three-plane crossing including a point corner part which comes into contact with three planes in a three-plane crossing structure having the three planes wherein the three planes come into contact and respective planes of the three planes also come into contact with each other and peripheral parts thereof, in structures such as dwelling houses.

### BACKGROUND OF THE INVENTION

So far, in order to cope with the enforcement of regulations regarding promotion of quality of waterproofing and airtight dwelling houses (dwelling houses having excellent waterproofing properties and airtightness) and the energy saving following high airtightness and high heat insulation of dwelling houses, waterproofing and airtight pressure-sensitive adhesive sheets have been used in gaps between a structure of dwelling house and a member or between members (mainly surroundings of sash openings or joints such as overlaps of moisture-penetrating waterproofing sheets) for the purpose of realizing waterproofing properties and/or airtightness (see JP-A-2003-138227, JP-A-2003-41233, and JP-A-9-209464 (The term “JP-A” as used herein means an “unexamined published Japanese patent application”.)). Conventional waterproofing and airtight pressure-sensitive adhesive sheets are, for example, constructed such that a butyl rubber, a rubberized asphalt, an acrylic adhesive, etc. is coated on one side of a substrate (such as non-woven fabrics, woven fabrics, and plastic films). These conventional waterproofing and airtight pressure-sensitive adhesive sheets can follow the movement of structures of dwelling houses or various members and exhibit waterproofing properties and airtightness over a long period of time.

However, in almost all cases, the conventional waterproofing and airtight pressure-sensitive adhesive sheets usually has an elongation at break of from 20 to 70% with the exception of a part thereof. This is because, in almost all cases, the conventional waterproofing and airtight pressure-sensitive adhesive sheets have been used in the planar portions in which no elongation of pressure-sensitive adhesive sheet is required, such as the horizontal plane, the vertical plane, or a rectangular portion of members, and it is not assumed that the pressure-sensitive adhesive sheet be applied in the elongated state. For this reason, in particular, it is difficult to apply waterproofing and airtight pressure-sensitive adhesive sheets to peripheral parts of three-plane crossings including a point corner part which comes into contact with three planes in a three-plane crossing structure having the three planes wherein the three planes come into contact and respective planes of the three planes also come into contact with each other and peripheral parts thereof. Even though a conventional waterproofing and airtight pressure-sensitive adhesive sheet can be applied to the peripheral part of three-plane crossing, peeling or wrinkle is generated in the sticking portion of the pressure-sensitive adhesive sheet. For this reason, a problem that the waterproofing properties and airtightness cannot be kept is generated.

The present inventors have developed a waterproofing and airtight pressure-sensitive adhesive sheet exhibiting a remarkably improved elongation at break, i.e., extensible waterproofing and airtight pressure-sensitive adhesive sheet. When such an extensible waterproofing and airtight pressure-sensitive adhesive sheet is employed, it becomes possible to maintain waterproofing properties and airtightness over a long period of time and also it becomes possible to apply waterproofing execution easily even when waterproofing execution is applied to the peripheral part of three-plane crossing. For this reason, it is desired to apply waterproofing execution effectively and easily to the peripheral part of three-plane crossing by means of the extensible waterproofing and airtight pressure-sensitive adhesive sheet.

### SUMMARY OF THE INVENTION

Accordingly, an object of the invention is to provide a waterproofing execution method of a three-plane crossing structure by means of an extensible waterproofing and airtight pressure-sensitive adhesive sheet, which is capable of effectively and easily applying waterproofing execution with excellent waterproofing properties and airtightness, to a peripheral part of three-plane crossing in a three-plane crossing structure using the extensible waterproofing and airtight pressure-sensitive adhesive sheet.

As a result of extensive studies for achieving the above object, the present inventors have found that waterproofing execution can be effectively and easily achieved when waterproofing execution is applied to a peripheral part of three-plane crossing in a three-plane crossing structure by a specific waterproofing execution method using an extensible waterproofing and airtight pressure-sensitive adhesive sheet. The invention is accomplished based on these findings.

Namely, the invention relates to a waterproofing execution method of a three-plane crossing structure by means of an extensible waterproofing and airtight pressure-sensitive adhesive sheet comprising sticking the extensible waterproofing and airtight pressure-sensitive adhesive sheet to a peripheral part of three-plane crossing including a point corner part which comes into contact with three planes in a three-plane crossing structure having the three planes wherein the three planes come into contact and respective planes of the three planes also come into contact with each other and peripheral parts thereof, which comprises the following processes (A) to (E);
(A): a step of folding the extensible waterproofing and airtight pressure-sensitive adhesive sheet having a form that a pressure-sensitive adhesive layer protected with a release liner is formed on one surface of a substrate in a form that its back side is positioned each other in an opposed manner toward the inner side and the pressure-sensitive adhesive surface is positioned toward the outer side so as to form a twofold state and subsequently folding the resulting sheet in a form that one pressure-sensitive adhesive surface at the outer side in a protected state with the release liner is positioned in an opposed manner toward the inner side and another pressure-sensitive adhesive surface at the outer side is positioned toward the outer side so as to form a fourfold state;
(B): a step of peeling off the release liner which protects the pressure-sensitive adhesive surface positioned at the outer side in the case that the sheet may be folded so as to form a fourfold state, at any of a stage before it is folded so as to form a twofold state, a stage after it is folded so as to form a twofold state and before it is folded so as to form a fourfold state, and a stage after it is folded so as to form a fourfold state, in the step (A);
(C): a step of closely sticking the pressure-sensitive adhesive surface exposed at the outer side in the extensible waterproofing and airtight pressure-sensitive adhesive sheet folded so as to form a fourfold state to two planes which form a linear corner part, to which a linear folded part folded so as to form a fourfold state is coincident or almost coincident, in the peripheral parts of three-plane crossing of the three-plane crossing structure, in a form that a twice-folded point edge part at which a linear folded part at the time when the sheet is folded so as to form a twofold state and a linear folded part at the time when the sheet is folded so as to form a fourfold state cross each other is coincident or almost coincident to the point corner part which comes into contact with the three planes in a three-plane crossing structure as well as the linear folded part at the time when the sheet is folded so as to form a fourfold state is coincident or almost coincident to the linear corner part at which any two planes come into contact with each other in the three-plane crossing structure and the linear folded part at the time when the sheet is folded so as to form a twofold state is coincident or almost coincident to the other two liner corner parts in the three-plane crossing structure, after the steps (A) and (B);
(D): a step of peeling off the release liner which protects the pressure-sensitive adhesive surface in an unstuck state in the extensible waterproofing and airtight pressure-sensitive adhesive sheet, after the step (C); and
(E): a step of closely sticking the pressure-sensitive adhesive surface exposed in an unstuck state in the extensible waterproofing and airtight pressure-sensitive adhesive sheet to the other one plane in the peripheral part of three-plane crossing of the three-plane crossing structure with extending the surface from the other two linear corner parts in the peripheral part of three-plane crossing of the three-plane crossing structure to the direction of the other one plane, after the step (D).

In the invention, the three-plane crossing structure may be any of (1) a three-plane crossing structure having three planes wherein the three planes come into contact and respective planes of the three planes come into contact with each other as well as all of the angles between respective planes are less than 180°, (2) a three-plane crossing structure having three planes wherein the three planes come into contact and respective planes of the three planes come into contact with each other as well as two of the angles between respective planes are less than 180° and one of the angles exceeds 180°; (3) a three-plane crossing structure having three planes wherein the three planes come into contact and respective planes of the three planes come into contact with each other as well as one of the angles between respective planes is less than 180° and two of the angles exceed 180°, or (4) a three-plane crossing structure having three planes wherein the three planes come into contact and respective planes of the three planes come into contact with each other as well as all of the angles between respective planes exceed 180°.

Moreover, as the extensible waterproofing and airtight pressure-sensitive adhesive sheet, the sheet is preferably provided with a split in the back at a site of the release liner corresponding to the linear folded part at the time when the sheet is folded into two, so as to be able to peel off the release liner which protects the pressure-sensitive adhesive surface positioned toward the outer side at the time when the sheet is folded so as to form a fourfold state.

Furthermore, it is preferable that the extensible waterproofing and airtight pressure-sensitive adhesive sheet comprises a rubber-made sheet as a substrate and a film layer having non-self-adhesive properties and pressure-sensitive adhesive layer-adhesive properties is formed on the surface opposite to the pressure-sensitive adhesive layer of the substrate. The above rubber-made sheet preferably comprises a rubber composition containing a synthetic rubber as a main component. The synthetic rubber of the rubber-made sheet is suitably at least one synthetic rubber selected from a butyl rubber, an ethylene-propylene rubber, and an ethylene-propylene-diene rubber. Moreover, the above film layer having non-self-adhesive properties and pressure-sensitive adhesive layer-adhesive properties is preferably formed with a film-forming composition containing an acrylic polymer or a long-chain alkyl compound.

According to the waterproofing execution method of a three-plane crossing structure by means of an extensible waterproofing and airtight pressure-sensitive adhesive sheet of the invention, it is possible to effectively and easily apply waterproofing execution with excellent waterproofing properties and airtightness to a peripheral part of three-plane crossing in a three-plane crossing structure using the extensible waterproofing and airtight pressure-sensitive adhesive sheet. Accordingly, when the waterproofing execution method of a three-plane crossing structure by means of an extensible waterproofing and airtight pressure-sensitive adhesive sheet of the invention is utilized in fixing a structure of dwelling house to a member or fixing members to each other, it becomes possible to prevent penetration of storm sewage into the inner side of a dwelling house and prevent dew condensation and corrosion in the inner side of a dwelling house over a long period of time.

### BRIEF DESCRIPTION OF THE DRAWINGS

FIGS. 1A, 1B and 1C are schematic views illustrating a state of folding the extensible waterproofing and airtight pressure-sensitive adhesive sheet, in Step (A) in the waterproofing execution method of a three-plane crossing structure of the invention.

FIG. 2 is a schematic view illustrating a peeled state of a release liner which protects an adhesive surface positioned at the outer side at the time when the extensible waterproofing and airtight pressure-sensitive adhesive sheet is folded so as to form a fourfold state, in Step (B) in the waterproofing execution method of a three-plane crossing structure of the invention.

FIG. 3 is a schematic view illustrating a state of sticking the extensible waterproofing and airtight pressure-sensitive adhesive sheet folded so as to form a fourfold state, to any two planes in a three-plane crossing structure, in Step (C) in the waterproofing execution method of a three-plane crossing structure of the invention.

FIG. 4 is a schematic view illustrating a peeled state of a release liner which protects an adhesive surface in an unstuck state in the extensible waterproofing and airtight pressure-sensitive adhesive sheet stuck to predetermined two planes in a peripheral part of three-plane crossing in a three-plane crossing structure, in Step (D) in the waterproofing execution method of a three-plane crossing structure of the invention.

FIG. 5 is a schematic view illustrating a state of sticking the extensible waterproofing and airtight pressure-sensitive adhesive sheet stuck to predetermined two planes in a peripheral part of three-plane crossing in a three-plane crossing structure, in Step (E) in the waterproofing execution method of a three-plane crossing structure of the invention.

FIGS. 6A, 6B, 6C and 6D are schematic views illustrating a part of an example of the three-plane crossing structure of the invention.

FIGS. 7A and 7B are schematic views to illustrating a part of an example of the extensible waterproofing and airtight pressure-sensitive adhesive sheet of the invention, FIG. 7A being a top view and FIG. 7B being a cross-sectional view.

FIG. 8 is a schematic cross-sectional view illustrating a part of an example of the extensible waterproofing and airtight pressure-sensitive adhesive sheet of the invention.

FIG. 9 is a schematic view illustrating an example of applying waterproofing execution to a peripheral part of three-plane crossing in a three-plane crossing structure.

FIG. 10 is a schematic view illustrating an example of applying waterproofing execution to a peripheral part of three-plane crossing in a three-plane crossing structure.

FIG. 11 is a schematic view illustrating an example of applying waterproofing execution to a peripheral part of three-plane crossing in a three-plane crossing structure.

FIG. 12 is a schematic view illustrating a method of evaluating waterproofing properties in the evaluation of waterproofing properties in the Examples.

### DESCRIPTION OF THE REFERENCE NUMERALS AND SIGNS:

1: Extensible waterproofing and airtight pressure-sensitive adhesive sheet

1a: Back side of extensible waterproofing and airtight pressure-sensitive adhesive sheet

1b: Pressure-sensitive adhesive surface side of extensible waterproofing and airtight pressure-sensitive adhesive sheet

2: Substrate

3: Pressure-sensitive adhesive layer

4: Release liner

5a: Inner side at the time when extensible waterproofing and airtight pressure-sensitive adhesive sheet 1 is folded so as to form a twofold state (twofold inner side)

5b: Outer side at the time when extensible waterproofing and airtight pressure-sensitive adhesive sheet 1 is folded so as to form a twofold state (twofold outer side)

5b1: One twofold outer side of twofold outer sides 5b

5b2: Another twofold outer side of twofold outer sides 5b

5c: Inner side at the time when extensible waterproofing and airtight pressure-sensitive adhesive sheet 1 is folded so as to form a fourfold state (fourfold inner side)

5d: Outer side at the time when extensible waterproofing and airtight pressure-sensitive adhesive sheet 1 is folded so as to form a fourfold state (fourfold outer side)

5d1: One fourfold outer side of fourfold outer sides 5d

5d2: Another fourfold outer side of fourfold outer sides 5d

6a: Linear folded part at the time when extensible waterproofing and airtight pressure-sensitive adhesive sheet 1 is folded so as to form a twofold state (twofold folded part)

6a1: Twofold folded part at one end part of twofold folded part 6a

6a2: Twofold folded part at another end part of twofold folded part 6a

6b: Linear folded part at the time when extensible waterproofing and airtight pressure-sensitive adhesive sheet 1 is folded so as to form a fourfold state (fourfold folded part)

6c: Twice-folded point edge part at which twofold folded part 6a and fourfold folded part 6b cross (folded edge part)

A: Linear corner part at which two planes of plane X and plane Y are come into contact with each other

A1 to A4: Linear corner part at which two planes of each plane (X1 to X4) and each plane (Y1 to Y4) are come into contact with each other

B: Linear corner part at which two planes of plane X and plane Z are come into contact with each other

B1 to B4: Linear corner part at which two planes of each plane (X1 to X4) and each plane (Z1 to Z4) are come into contact with each other

C: Linear corner part at which two planes of plane Y and plane Z are come into contact with each other

C1 to C4: Linear corner part at which two planes of each plane (Y1 to Y4) and each plane (Z1 to Z4) are come into contact with each other

D: Point corner part at which three planes of plane X, plane Y, and plane Z are come into contact with each other

D1 to D4: Point corner part at which two planes of each plane (X1 to X4), each plane (Y1 to Y4), and each plane (Z1 to Z4) are come into contact with each other

W: Structure having three planes wherein the three planes come into contact and respective planes of the three planes also come into contact with each other (three-plane crossing structure)

W1 to W4: Three-plane crossing structures, respectively

Wa: Part including point corner part D and peripheral part thereof (peripheral part of three-plane crossing)

X: Each plane in three-plane crossing structure

X1 to X4: Each plane in each three-plane crossing structure (W1 to W4)

Y: Each plane in three-plane crossing structure

Y1 to Y4: Each plane in each three-plane crossing structure (W1 to W4)

Z: Each plane in three-plane crossing structure

Z1 to Z4: Each plane in each three-plane crossing structure (W1 to W4)

11: Extensible waterproofing and airtight pressure-sensitive adhesive sheet

21: Substrate

31: Pressure-sensitive adhesive layer

41: Release liner

41a: Release liner part at one end part in release liner 41

41b: Release liner part at another end part in release liner 41

41c: Split line in the back provided on release liner

12: Extensible waterproofing and airtight pressure-sensitive adhesive sheet

22: Rubber-made sheet

32: Pressure-sensitive adhesive layer

42: Release liner

7: Film layer having non-self-adhesive properties and pressure-sensitive adhesive layer-adhesive properties (non-self-adhesive and non-releasing film layer)

81: Sash frame in dwelling house exterior underlying structure

81a: Peripheral part of three-plane crossing including a point corner part wherein three planes come into contact with each other and peripheral part thereof in sash frame 81

81b: Outer wall part

81c: Sash insert part

91: Extensible waterproofing and airtight pressure-sensitive adhesive sheet stuck to peripheral part of three-plane crossing 81a

82: Ventilating fan frame in dwelling house exterior underlying structure

82a: Peripheral part of three-plane crossing including a point corner part wherein three planes come into contact with each other and peripheral part thereof in ventilating fan frame 82

82b: Outer wall part

82c: Ventilating fan insert part

92: Extensible waterproofing and airtight pressure-sensitive adhesive sheet stuck to peripheral part of three-plane crossing 82a

83: Junction part between handrail part and wall part in dwelling house exterior underlying structure 83a: Peripheral part of three-plane crossing including a point corner part wherein three planes come into contact with each other and peripheral part thereof in junction part between handrail part and wall part 83

83b: Handrail wall part

83c: Wall part

84: Level difference part of stepwise handrail part in dwelling house exterior underlying structure

84a: Peripheral part of three-plane crossing including a point corner part wherein three planes come into contact with each other and peripheral part thereof in level difference part of stepwise handrail part 84

93: Extensible waterproofing and airtight pressure-sensitive adhesive sheet stuck to peripheral part of three-plane crossing 83a

94: Extensible waterproofing and airtight pressure-sensitive adhesive sheet stuck to peripheral part of three-plane crossing 84a

10a: One-sided specimen (width 100 mm)

10b: Other-sided specimen (width 100 mm)

10c: Cylinder (outer diameter 70 mm, made of plastic)

10d: Water

### DETAILED DESCRIPTION OF THE INVENTION

The waterproofing execution method of a three-plane crossing structure by means of an extensible waterproofing and airtight pressure-sensitive adhesive sheet in the invention is a waterproofing execution method of a three-plane crossing structure comprising sticking the extensible waterproofing and airtight pressure-sensitive adhesive sheet to a peripheral part of three-plane crossing including a point corner part which comes into contact with three planes in a three-plane crossing structure having the three planes wherein the three planes come into contact and respective planes of the three planes also come into contact with each other and peripheral parts thereof, and comprises the following processes (A) to (E).
(A): a step of folding the extensible waterproofing and airtight pressure-sensitive adhesive sheet having a form that a pressure-sensitive adhesive layer protected with a release liner is formed on one surface of a substrate in a form that its back side is positioned each other in an opposed manner toward the inner side and the pressure-sensitive adhesive surface is positioned toward the outer side so as to form a twofold state and subsequently folding the resulting sheet in a form that one pressure-sensitive adhesive surface at the outer side in a protected state with the release liner is positioned in an opposed manner toward the inner side and another pressure-sensitive adhesive surface at the outer side is positioned toward the outer side so as to form a fourfold state;
(B): a step of peeling off the release liner which protects the pressure-sensitive adhesive surface positioned at the outer side in the case that the sheet may be folded so as to form a fourfold state, at any of a stage before it is folded so as to form a twofold state, a stage after it is folded so as to form a twofold state and before it is folded so as to form a fourfold state, and a stage after it is folded so as to form a fourfold state, in the step (A);
(C): A step of closely sticking the pressure-sensitive adhesive surface exposed at the outer side in the extensible waterproofing and airtight pressure-sensitive adhesive sheet folded so as to form a fourfold state to two planes which form a linear corner part, to which a linear folded part folded so as to form a fourfold state is coincident or almost coincident, in the peripheral parts of three-plane crossing of the three-plane crossing structure, in a form that a twice-folded point edge part at which a linear folded part at the time when the sheet is folded so as to form a twofold state and a linear folded part at the time when the sheet is folded so as to form a fourfold state cross each other is coincident or almost coincident to the point corner part which comes into contact with the three planes in a three-plane crossing structure as well as the linear folded part at the time when the sheet is folded so as to form a fourfold state is coincident or almost coincident to the linear corner part at which any two planes come into contact with each other in the three-plane crossing structure and the linear folded part at the time when the sheet is folded so as to form a twofold state is coincident or almost coincident to the other two liner corner parts in the three-plane crossing structure, after the steps (A) and (B);
(D): a step of peeling off the release liner which protects the pressure-sensitive adhesive surface in an unstuck state in the extensible waterproofing and airtight pressure-sensitive adhesive sheet, after the step (C); and
(E): a step of closely sticking the pressure-sensitive adhesive surface exposed in an unstuck state in the extensible waterproofing and airtight pressure-sensitive adhesive sheet to the other one plane in the peripheral part of three-plane crossing of the three-plane crossing structure with extending the surface from the other two linear corner parts in the peripheral part of three-plane crossing of the three-plane crossing structure to the direction of the other one plane, after the step (D).
   [Step (A)]

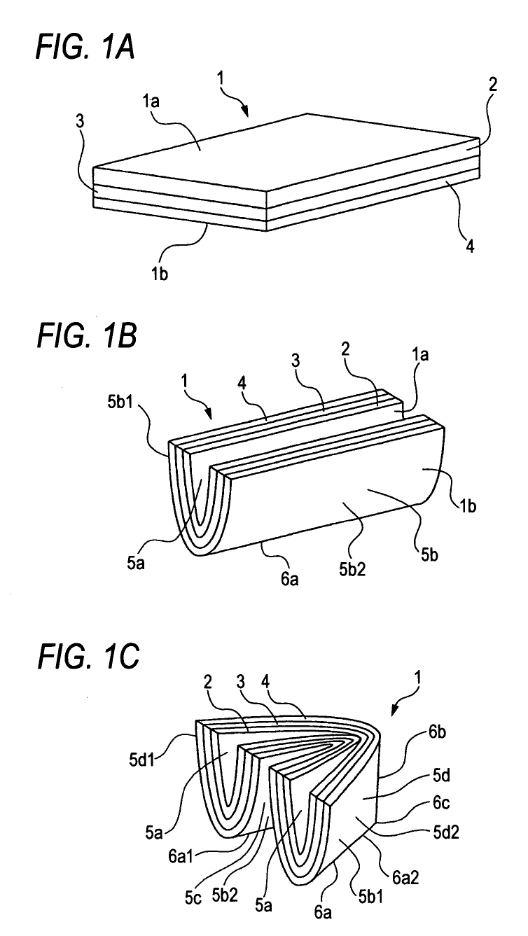

In Step (A), an extensible waterproofing and airtight pressure-sensitive adhesive sheet having a form that a pressure-sensitive adhesive layer protected with a release liner is formed on one surface of a substrate is used as the extensible waterproofing and airtight pressure-sensitive adhesive sheet. Such an extensible waterproofing and airtight pressure-sensitive adhesive sheet is folded in a form that its back side is positioned each other in an opposed manner toward the inner side and the pressure-sensitive adhesive surface is positioned toward the outer side so as to form a twofold state and subsequently the resulting sheet is folded in a form that one pressure-sensitive adhesive surface at the outer side in a protected state with the release liner is positioned in an opposed manner toward the inner side and another pressure-sensitive adhesive surface at the outer side is positioned toward the outer side so as to form a fourfold state, as shown in FIGS. 1A, 1B and 1C.

FIGS. 1A, 1B and 1C are schematic views illustrating a state of folding the extensible waterproofing and airtight pressure-sensitive adhesive sheet in Step (A) in the waterproofing execution method of a three-plane crossing structure of the invention. In FIGS. 1A, 1B and 1C, 1 is an extensible waterproofing and airtight pressure-sensitive adhesive sheet, 1a is a backside of the extensible waterproofing and airtight pressure-sensitive adhesive sheet, 1b is a pressure-sensitive adhesive surface side of the extensible waterproofing and airtight pressure-sensitive adhesive sheet, 2 is a substrate, 3 is a pressure-sensitive adhesive layer, 4 is a release liner, 5a is an inner side at the time when extensible waterproofing and airtight pressure-sensitive adhesive sheet 1 is folded so as to form a twofold state (sometimes referred to as “twofold inner side”), 5b is an outer side at the time when extensible waterproofing and airtight pressure-sensitive adhesive sheet 1 is folded so as to form a twofold state (sometimes referred to as “twofold outer side”), 5b1 is one twofold outer side of twofold outer sides 5b, 5b2 is another twofold outer side of twofold outer sides 5b, 5c is an inner side at the time when extensible waterproofing and airtight pressure-sensitive adhesive sheet 1 is folded so as to form a fourfold state (sometimes referred to as “fourfold inner side”), 5d is an outer side at the time when extensible waterproofing and airtight pressure-sensitive adhesive sheet 1 is folded so as to form a fourfold state (sometimes referred to as “fourfold outer side”), 5d1 is one fourfold outer side of fourfold outer sides 5d, 5d2 is another fourfold outer side of fourfold outer sides 5d, 6a is a linear folded part at the time when extensible waterproofing and airtight pressure-sensitive adhesive sheet 1 is folded so as to form a twofold state (sometimes referred to as “twofold folded part”), 6a1 is a twofold folded part at one end part of twofold folded part 6a, 6a2 is a twofold folded part at another end part of twofold folded part 6a, 6b is a linear folded part at the time when extensible waterproofing and airtight pressure-sensitive adhesive sheet 1 is folded so as to form a fourfold state (sometimes referred to as “fourfold folded part”), and 6c is a twice-folded point edge part at which twofold folded part 6a and fourfold folded part 6b cross (sometimes referred to as “folded edge part”).

The extensible waterproofing and airtight pressure-sensitive adhesive sheet 1 shown in FIG. 1A is composed of the substrate 2, the pressure-sensitive adhesive layer 3 formed on one side of the substrate 2, and the release liner 4 protecting the surface (pressure-sensitive adhesive surface) of the pressure-sensitive adhesive layer 3. Therefore, the surface 1a [upper surface in FIG. 1A] at the substrate 2 side of the extensible waterproofing and airtight pressure-sensitive adhesive sheet 1 is a surface at the backside and the surface 1b [lower surface in FIG. 1A] at the release liner 4 side is a surface at the pressure-sensitive adhesive surface side.

As shown in FIG. 1B, the above extensible waterproofing and airtight pressure-sensitive adhesive sheet 1 is folded in a form that the surface 1a at the substrate 2 side comes to the twofold inner side 5a and the surface 1b at the release liner 4 side comes to the twofold outer side 5b so as to form a twofold state. That is, the extensible waterproofing and airtight pressure-sensitive adhesive sheet 1 is folded in a form that its back side is positioned each other in an opposed manner toward the inner side 5a and the pressure-sensitive adhesive surface is positioned toward the outer side 5b so as to form a twofold state at the twofold folded part 6a.

In this connection, in FIG. 1B, the twofold outer side 5b can be divided into the twofold outer side 5b1 at one end part and the twofold outer side 5b2 at another end part, the twofold folded part 6a being a border.

After the extensible waterproofing and airtight pressure-sensitive adhesive sheet 1 is folded so as to form a twofold state as shown in FIG. 1B, the extensible waterproofing and airtight pressure-sensitive adhesive sheet 1 folded so as to form a twofold state is folded in a form that the surface 1b at the release liner 4 side positioned at one twofold outer side 5b1 of the surface 1b at the release liner 4 side which has become the twofold outer side 5b comes to the fourfold inner side 5c and the surface 1b at the release liner 4 side positioned at another twofold outer side 5b2 comes to the fourfold outer side 5d. Namely, after the extensible waterproofing and airtight pressure-sensitive adhesive sheet 1 is folded so as to form a twofold state, the extensible waterproofing and airtight pressure-sensitive adhesive sheet 1 folded so as to form a twofold state is folded in a form that one pressure-sensitive adhesive surface at the twofold outer side 5b1 in a protected state with the release liner is positioned in an opposed manner at the fourfold inner side 5c and another pressure-sensitive adhesive surface at the twofold outer side 5b2 is positioned at the fourfold outer side 5d so as to form a fourfold state at the fourfold folded art 6b, as shown in FIG. 1C.

In this connection, in FIG. 1c, the fourfold outer side 5d can be divided into the fourfold outer side 0.5d1 at one end part and the fourfold outer side 5d2 at another end part, the fourfold folded part 6b being a border. Moreover, since the sheet is folded in a fourfold state, the folded point edge part 6c that is a twice-folded point edge part is formed. At the folded point edge part 6c, the twofold folded part 6a and the fourfold folded part 6b cross. Therefore, an expression that three linear folded parts of the twofold folded part 6a1, the twofold folded part 6a2, and the fourfold folded part 6b cross may be also possible.

In FIG. 1B and FIG. 1C, the twofold folded part 6a and the fourfold folded part 6b are folded parts at the folding in a rounded form but may be folded parts at the folding in a sharp form. Namely, a folding manner at the folding so as to form a twofold state or a fourfold state may be a folding manner in a rounded form such as U-shape one or a folding manner in a sharp form such as V-shape one.

[Step (B)]

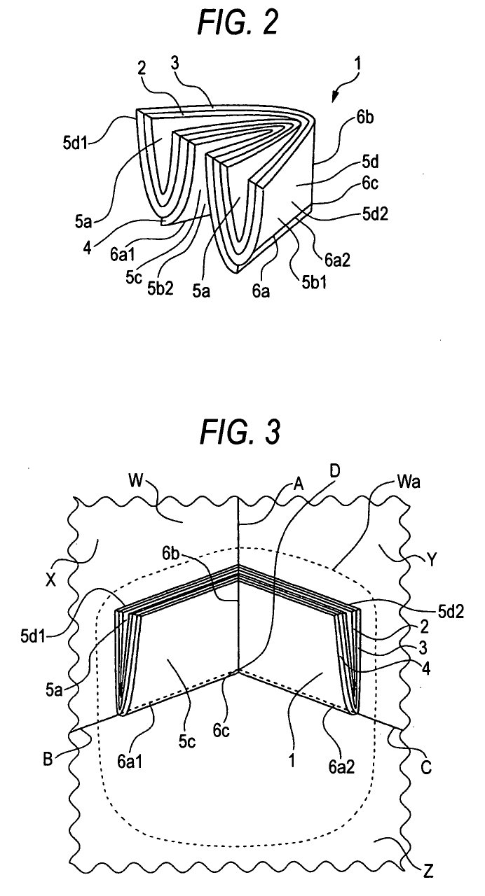

In Step B, in the extensible waterproofing and airtight pressure-sensitive adhesive sheet, as shown in FIG. 2, the release liner which protects the pressure-sensitive adhesive surface positioned at the outer side in the case that the sheet may be folded so as to form a fourfold state is peeled off. FIG. 2 is a schematic view illustrating a peeled state of a release liner which protects an adhesive surface positioned at the outer side at the time when the extensible waterproofing and airtight pressure-sensitive adhesive sheet is folded so as to form a fourfold state, in Step (B) in the waterproofing execution method of a three-plane crossing structure of the invention. In FIG. 2, other reference numerals and signs (reference numerals and signs such as 1, 2, 3, 4, 5a, 5b1, 5b2, 5c, 5d, 5d1, 5d2, 6a, 6a1, 6a2, 6b, and 6c) are the same as describe above.

The extensible waterproofing and airtight pressure-sensitive adhesive sheet 1 shown in FIG. 2 has a constitution of being folded so as to form a fourfold state and has a constitution that, of the release liner 4, the part of the release liner 4 positioned at the fourfold outer side 5d is peeled off to expose the pressure-sensitive adhesive surface positioned at the fourfold outer side 5d and, on the other hand, the part of the release liner 4 positioned at the fourfold inner side 5c is not peeled off to maintain the state that the pressure-sensitive adhesive surface positioned at the fourfold inner side 5c is protected with the release liner 4.

Such a step of peeling off the part of the release liner 4 positioned at the fourfold outer side 5d may be conducted at any stage during Step (A) or at a stage after completion of Step (A). Specifically, the part of the release liner 4 positioned at the fourfold outer side 5d may be peeled off in Step (A), (i) before the extensible waterproofing and airtight pressure-sensitive adhesive sheet 1 is folded so as to form a twofold state, (ii) before the extensible waterproofing and airtight pressure-sensitive adhesive sheet 1 folded so as to form a twofold state is folded so as to form a fourfold state, or (iii) after preparation of the extensible waterproofing and airtight pressure-sensitive adhesive sheet 1 folded so as to form a fourfold state. Namely, the release liner which protects the pressure-sensitive adhesive surface positioned at the outer side in the case that the sheet may be folded so as to form a fourfold state is peeled off at any of a stage before it is folded so as to form a twofold state, a stage after it is folded so as to form a twofold state and before it is folded so as to form a fourfold state, and a stage after it is folded so as to form a fourfold state, in the step (A).

[Step C]

In Step (C), the pressure-sensitive adhesive surface exposed at the outer side in the extensible waterproofing and airtight pressure-sensitive adhesive sheet folded so as to form a fourfold state is closely stuck to any two planes in a three-plane crossing structure having three planes wherein the three planes come into contact and respective planes of the three planes also come into contact with each other, as shown in FIG. 3. FIG. 3 is a schematic view illustrating a state of sticking the extensible waterproofing and airtight pressure-sensitive adhesive sheet folded so as to form a fourfold state, to any two planes in a three-plane crossing structure, in Step (C) in the waterproofing execution method of a three-plane crossing structure of the invention and shows an essential part of the three-plane crossing structure. In FIG. 3, W is a structure having three planes wherein the three planes come into contact and respective planes of the three planes also come into contact with each other (three-plane crossing structure) and X, Y, and Z each represents each plane in three-plane crossing structure W. Moreover, A represents a linear corner part at which two planes of plane X and plane Y are come into contact with each other, B represents a linear corner part at which two planes of plane X and plane Z are come into contact with each other, C represents a linear corner part at which two planes of plane Y and plane Z are come into contact with each other, D represents a point corner part at which three planes of plane X, plane Y, and plane Z are come into contact with each other, and Wa represents part including point corner part D and peripheral part thereof (peripheral part of three-plane crossing). In FIG. 3, other reference numerals and signs (reference numerals and signs such as 1, 2, 3, 4, 5a, 5c, 5d1, 5d2, 6a1, 6a2, 6b, and 6c) are the same as describe above.

In FIG. 3, the three-plane crossing structure W has three planes (X, Y, Z) wherein the three planes come into contact and respective planes of the three planes also come into contact with each other. Specifically, the three-plane crossing structure W has a constitution that the plane X, the plane Y, and the plane Z are come into contact with the point corner part D as well as the plane X and the plane Y come into contact with the linear corner part A, the plane X and the plane Z come into contact with the linear corner part B, and the plane Y and the plane Z come into contact with the linear corner part C. In this connection, in the three-plane crossing structure W, all the angels (plane angles) formed by bringing each two planes of the three planes into contact with each other are about 90° in the three-plane crossing structure W.

In FIG. 3, the extensible waterproofing and airtight pressure-sensitive adhesive sheet 1 folded so as to form a twofold state is applied to such a three-plane crossing structure W. Specifically, the extensible waterproofing and airtight pressure-sensitive adhesive sheet 1 folded so as to form a fourfold state is closely stuck to two planes (X, Y) in the three-plane crossing structure W in a: form that the folded point edge part 6c is coincident or almost coincident to the point corner part D as well as the fourfold folded part 6b is coincident or almost coincident to the linear corner part A in the three-plane crossing structure W and the twofold folded part 6a1 is coincident or almost coincident to the liner corner part B in the three-plane crossing structure W and also the twofold folded part 6a2 is coincident or almost coincident to the liner corner part C in the three-plane crossing structure W so that the pressure-sensitive adhesive surface exposed at the fourfold outer side 5d1 comes into contact with the plane X and the pressure-sensitive adhesive surface exposed at the fourfold outer side 5d2 comes into contact with the plane Y.

Thus, in Step (C), after the steps (A) and (B), the pressure-sensitive adhesive surface exposed at the fourfold outer side 5d in the extensible waterproofing and airtight pressure-sensitive adhesive sheet 1 folded so as to form a fourfold state is closely stuck to two planes which form a linear corner part A, to which the fourfold folded part 6b folded so as to form a fourfold state is coincident or almost coincident, in the peripheral part Wa of three-plane crossing including the point corner part D and the peripheral part thereof in the three-plane crossing structure W, in a form that the folded point edge part 6c at which the twofold folded-part 6a at the time when the sheet is folded so as to form a twofold state and the fourfold folded part 6b at the time when the sheet is folded so as to form a fourfold state cross each other is coincident or almost coincident to the point corner part D which comes into contact with the three planes in a three-plane crossing structure W as well as the fourfold folded part 6b at the time when the sheet is folded so as to form a fourfold state is coincident or almost coincident to the linear corner part A at which any two planes come into contact with each other in the three-plane crossing structure W and the twofold folded part 6a at the time when the sheet is folded so as to form a twofold state is coincident or almost coincident to the other two liner corner parts (B, C) in the three-plane crossing structure W.

[Step (D)]

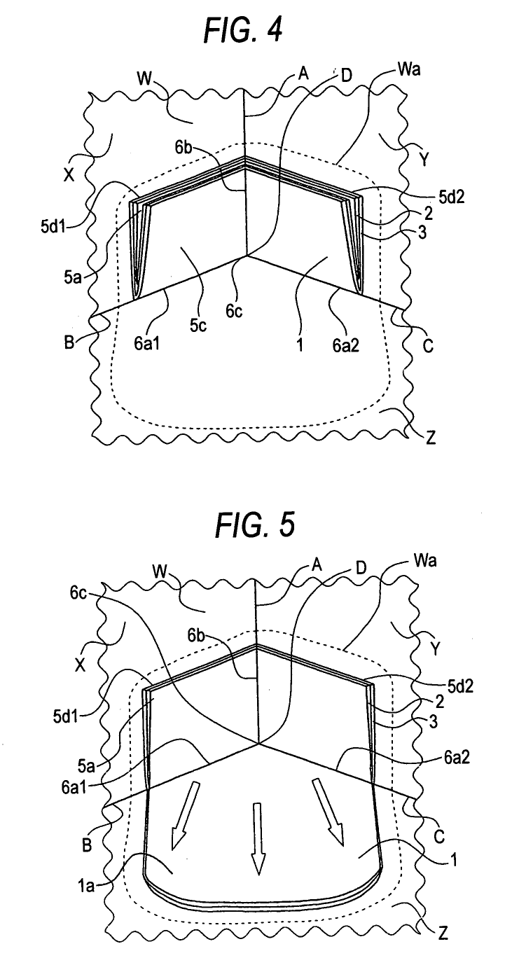

In Step (D), in the extensible waterproofing and airtight pressure-sensitive adhesive sheet, as shown in FIG. 4, the release liner which protects the pressure-sensitive adhesive surface in an unstuck state was peeled off. FIG. 4 is a schematic view illustrating a peeled state of a release liner which protects a pressure-sensitive adhesive surface in an unstuck state in the extensible waterproofing and airtight pressure-sensitive adhesive sheet stuck to predetermined two planes in a peripheral part of three-plane crossing in a three-plane crossing structure, in Step (D) in the waterproofing execution method of a three-plane crossing structure of the invention. In FIG. 4, each reference numeral and sign is the same as describe above.

In FIG. 4, the extensible waterproofing and airtight pressure-sensitive adhesive sheet 1 stuck to the two planes (X, Y) in the peripheral part Wa of three-plane crossing in a three-plane crossing structure W has a constitution that the pressure-sensitive adhesive surface positioned at the fourfold outer side 5d (fourfold outer side 5d1 and fourfold outer side 5d2) is stuck to the two planes (X, Y) in the peripheral part Wa of three-plane crossing and, on the other hand, the pressure-sensitive adhesive surface in an unstuck state positioned at the fourfold inner side 5c is exposed in an unstuck state, the release liner protecting the pressure-sensitive adhesive surface having been peeled off.

Thus, in Step (D), the release liner which protects the pressure-sensitive adhesive surface in an unstuck state in the extensible waterproofing and airtight pressure-sensitive adhesive sheet is peeled off after the step (C).

[Step (E)]

In Step (E), in the extensible waterproofing and airtight pressure-sensitive adhesive sheet stuck to the predetermined two planes in a peripheral part of three-plane crossing in a three-plane crossing structure, as shown in FIG. 5, the pressure-sensitive adhesive surface exposed in an unstuck state is stuck to the other one plane in the peripheral part of three-plane crossing of the three-plane crossing structure in a predetermined form. FIG. 5 is a schematic view illustrating a state of sticking the extensible waterproofing and airtight pressure-sensitive adhesive sheet stuck to predetermined two planes in a peripheral part of three-plane crossing in a three-plane crossing structure, in Step (E) in the waterproofing execution method of a three-plane crossing structure of the invention. In FIG. 5, each reference numeral and sign is the same as describe above.

In FIG. 5, in the extensible waterproofing and airtight pressure-sensitive adhesive sheet 1 stuck to the two planes (X, Y) in the peripheral part Wa of three-plane crossing in a three-plane crossing structure W, the pressure-sensitive adhesive surface in an unstuck state positioned at the fourfold inner side 5c is closely stuck to the other one plane Z in the peripheral part Wa of three-plane crossing in a three-plane crossing structure W with extending the surface from the linear corner part B by the plane X and the plane Z and the linear corner part C by the plane Y and the plane Z to the direction of the plane Z (in FIG. 5, with extending it to the arrowed directions).

Thus, in Step (E), after Step (D), the pressure-sensitive adhesive surface exposed in an unstuck state in the extensible waterproofing and airtight pressure-sensitive adhesive sheet is closely stuck to the other one plane in the peripheral part of three-plane crossing of the three-plane crossing structure with extending the surface from the other two linear corner parts in the peripheral part of three-plane crossing of the three-plane crossing structure to the direction of the other one plane.

[Three-Plane Crossing Structure]

In the invention, the three-plane crossing structure is not particularly limited as far as it is a structure having three planes wherein the three planes come into contact and respective planes of the three planes also come into contact with each other.

In this connection, of the three planes in the three-plane crossing structure, at least any one plane may be not a planer plane but a non-planer plane such as a curved plane.

In the three-plane crossing structure, the angles between respective planes (plane angles) are not particularly limited and may be less than 180° or may exceed 180°.

When the plane angle is less than 180°, the linear corner part that is a site at which the two planes forming the plane angle come into contact with each other has formed a concave linear corner part. On the other hand, when the plane angle exceeds 180°, the linear corner part that is a site at which the two planes forming the plane angle come into contact with each other has formed a convex linear corner part.

In such a three-plane crossing structure, there exist three plane angles formed by the contact of respective planes of the three planes with each other and the three plane angles can be, for example, classified into four combinations, i.e., (1) a combination that all the plane angles are less than 180°, (2) a combination that two of them are less than 180° and one exceeds 180°, (3) a combination that one of them is less than 180° and two exceed 180°, and (4) a combination that all of them exceed 180°.

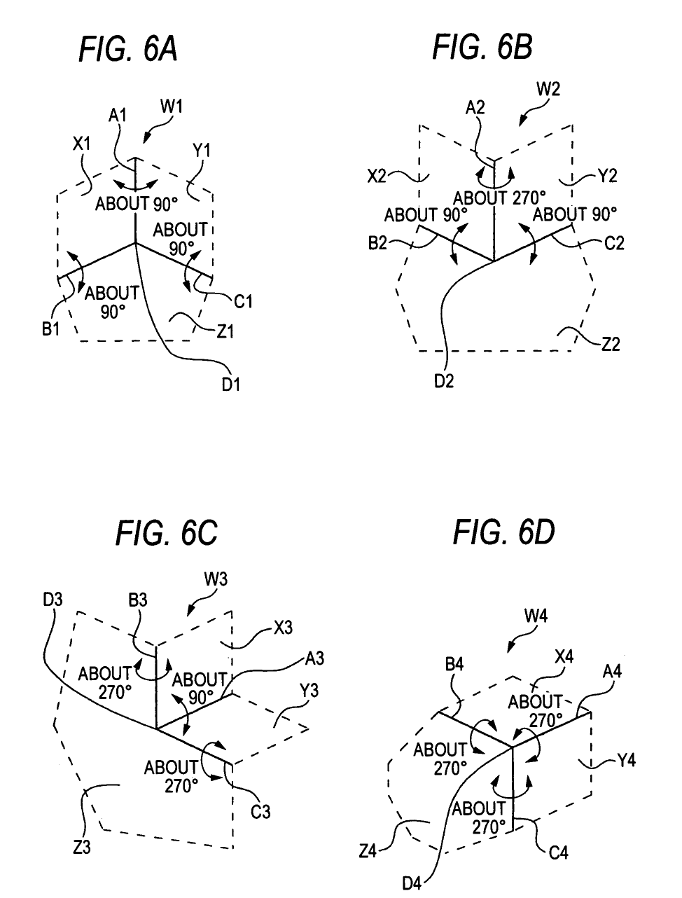

Accordingly, as the three-plane crossing structure, there may be exemplified (1) a three-plane crossing structure having three planes wherein the three planes come into contact and respective planes of the three planes come into contact with each other as well as all of the angles between respective planes are less than 180° (sometimes referred to as “all concave three-plane crossing structure”) as shown in FIG. 6A, (2) a three-plane crossing structure having three planes wherein the three planes come into contact and respective planes of the three planes come into contact with each other as well as two of the angles between respective planes are less than 180° and one of the angles exceeds 180° (sometimes referred to as “concavo-convex three-plane crossing structure”) as shown in FIG. 6B, (3) a three-plane crossing structure having three planes wherein the three planes come into contact and respective planes of the three planes come into contact with each other as well as one of the angles between respective planes is less than 180° and two of the angles exceed 180° (sometimes referred to as “convexo-concave three-plane crossing structure”) as shown in FIG. 6C, or (4) a three-plane crossing structure having three planes wherein the three planes come into contact and respective planes of the three planes come into contact with each other as well as all of the angles between respective planes exceed 180° (sometimes referred to as “all convex three-plane crossing structure”) as shown in FIG. 6D.

FIGS. 6A to 6D each is a schematic view illustrating a part of an example of the three-plane crossing structure of the invention. In FIG. 6A, W1 is a three-plane crossing structure, X1, Y1, and 71 each each plane of the three-plane crossing structure W1, A1, B1, and C1 each is a linear corner part by any two planes of the three planes (X1, Y1, and Z1), and D1 is a point corner part by the three planes (X1, Y1, and Z1). In the three-plane crossing structure W1 shown in FIG. 6A, the plane angle by the two planes of the plane X1 and the plane Y1 is about 90°, the plane angle by the two planes of the plane X1 and the plane Z1 is about 90°, and the plane angle by the two planes of the plane Y1 and the plane Z1 is about 90°. Therefore, the three-plane crossing structure W1 can be classified into the all concave three-plane crossing structure.

In FIG. 6B, W2 is a three-plane crossing structure, X2, Y2, and Z2 each is each plane of the three-plane crossing structure W2, A2, B2, and C2 each is a linear corner part by any two planes of the three planes (X2, Y2, and Z2), and D2 is a point corner part by the three planes (X2, Y2, and Z2). In the three-plane crossing structure W2 shown in FIG. 6B, the plane angle by the two planes of the plane X2 and the plane Y2 is about 270°, the plane angle by the two planes of the plane X2 and the plane Z2 is about 90°, and the plane angle by the two planes of the plane Y2 and the plane Z2 is about 90°. Therefore, the three-plane crossing structure W2 can be classified into the concavo-convex three-plane crossing structure.

In FIG. 6C, W3 is a three-plane crossing structure, X3, Y3, and Z3 each is each plane of the three-plane crossing structure W3, A3, B3, and C3 each is a linear corner part by any two planes of the three planes (X3, Y3, and Z3), and D2 is a point corner part by the three planes (X3, Y3, and Z3). In the three-plane crossing structure W3 shown in FIG. 6C, the plane angle by the two planes of the plane X3 and the plane Y3 is about 90°, the plane angle by the two planes of the plane X3 and the plane Z3 is about 270°, and the plane angle by the two planes of the plane Y3 and the plane Z3 is about 270°. Therefore, the three-plane crossing structure W3 can be classified into the convexo-concave three-plane crossing structure.

In FIG. 6D, W4 is a three-plane crossing structure, X4, Y4, and Z4 each is each plane of the three-plane crossing structure W4, A4, B4, and C4 each is a linear corner part by any two planes of the three planes (X4, Y4, and Z4), and D4 is a point corner part by the three planes (X4, Y4, and Z4). In the three-plane crossing structure W4 shown in FIG. 6D, the plane angle by the two planes of the plane X4 and the plane Y4 is about 270°, the plane angle by the two planes of the plane X4 and the plane Z4 is about 270°, and the plane angle by the two planes of the plane Y4 and the plane Z4 is about 270°. Therefore, the three-plane crossing structure W4 can be classified into the all convex three-plane crossing structure.

In the case that the waterproofing execution of a three-plane crossing structure by means of an extensible-waterproofing and airtight pressure-sensitive adhesive sheet is conducted by applying the extensible waterproofing and airtight pressure-sensitive adhesive sheet 1 shown in FIGS. 1A, 1B, 1C and 2 to the three-plane crossing structure W1 as the all concave three-plane crossing structure shown in FIG. 6A, the extensible waterproofing and airtight pressure-sensitive adhesive sheet is first folded so as to expose the pressure-sensitive adhesive surface at the outer side and form a fourfold state as shown in FIG. 2 and then is closely stuck to any two planes of the three planes in the three-plane crossing structure W1 in a form that the folded point edge part 6c is coincident or almost coincident to the point corner part D1 as well as the fourfold folded part 6b is coincident or almost coincident to any linear corner part of the linear corner parts A1, B1, and C1 and the twofold folded part 6a1 and the twofold folded part 6a2 are coincident or almost coincident to the other liner corner parts, respectively so that the pressure-sensitive adhesive surface exposed at the fourfold outer side 5d1 and the pressure-sensitive adhesive surface exposed at the fourfold outer side 5d2 each comes into contact with any of the plane X1, the plane Y1, and the plane Z1. Thereafter, the release liner which protects the pressure-sensitive adhesive surface in an unstuck state is peeled off and then the pressure-sensitive adhesive surface in an unstuck state positioned at the fourfold inner side 5c is closely stuck to the other one plane in the three-plane crossing structure W1 with extending the surface from the linear corner parts to which the twofold folded part 6a1 and the twofold folded part 6a2 each is coincident or almost coincident to the direction of the plane which is not yet stuck, whereby waterproofing execution by means of the extensible waterproofing and airtight pressure-sensitive adhesive sheet can be applied to the all concave three-plane crossing structure.

Thus, in the case that the waterproofing execution by means of the extensible waterproofing and airtight pressure-sensitive adhesive sheet is applied to the all concave three-plane crossing structure, since all the plane angles between respective planes are less than 180° in the all concave three-plane crossing structure, the extensible waterproofing and airtight pressure-sensitive adhesive sheet may be stuck to the peripheral part of the all concave three-plane crossing structure so that the fourfold folded part in the extensible waterproofing and airtight pressure-sensitive adhesive sheet is coincident or almost coincident to any of the linear corner parts.

Moreover, in the case that the waterproofing execution of a three-plane crossing structure by means of an extensible waterproofing and airtight pressure-sensitive adhesive sheet is conducted by applying the extensible waterproofing and airtight pressure-sensitive adhesive sheet 1 shown in FIGS. 1A, 1B, 1C and 2 to the three-plane crossing structure W2 as the concavo-convex three-plane crossing structure shown in FIG. 6B, the extensible waterproofing and airtight pressure-sensitive adhesive sheet is first folded so as to expose the pressure-sensitive adhesive surface at the outer side and form a fourfold state as shown in FIG. 2 and then is closely stuck to the two planes (X2, Y2) in the three-plane crossing structure W2 in a form that the folded point edge part 6c is coincident or almost coincident to the point corner part D2 as well as the fourfold folded part 6b is coincident or almost coincident to the linear corner part A2 and the twofold folded part 6a1 is coincident or almost coincident to the linear corner part B2 and the twofold folded part 6a2 is coincident or almost coincident to the liner corner part C2 so that the pressure-sensitive adhesive surface exposed at the fourfold outer side 5d1 comes into contact with the plane X2 and the pressure-sensitive adhesive surface exposed at the fourfold outer side 5d2 comes into contact with the plane Y2. Thereafter, the release liner which protects the pressure-sensitive adhesive surface in an unstuck state is peeled off and then the pressure-sensitive adhesive surface in an unstuck state positioned at the fourfold inner side 5c is closely stuck to the other one plane Z2 in the three-plane crossing structure W2 with extending the surface from the linear corner parts B2 and c2 to the direction of the plane Z2, whereby waterproofing execution by means of the extensible waterproofing and airtight pressure-sensitive adhesive sheet can be applied to the concavo-convex three-plane crossing structure.

Thus, in the case that the waterproofing execution by means of the extensible waterproofing and airtight pressure-sensitive adhesive sheet is applied to the concavo-convex three-plane crossing structure, since one of the plane angles between respective planes exceeds 180° and two are less than 180° in the concavo-convex three-plane crossing structure, it is important to stick the extensible waterproofing and airtight pressure-sensitive adhesive sheet to the peripheral part of the concavo-convex three-plane crossing structure so that the fourfold folded part in the extensible waterproofing and airtight pressure-sensitive adhesive sheet is coincident or almost coincident to the linear corner part where two planes come into contact with each other at a plane angle exceeding 180°.

Furthermore, in the case that the waterproofing execution of a three-plane crossing structure by means of an extensible waterproofing and airtight pressure-sensitive adhesive sheet is conducted by applying the extensible waterproofing and airtight pressure-sensitive adhesive sheet 1 shown in FIGS. 1A, 1B, 1C and 2 to the three-plane crossing structure W3 as the convexo-concave three-plane crossing structure shown in FIG. 6C, the extensible waterproofing and airtight pressure-sensitive adhesive sheet is first folded so as to expose the pressure-sensitive adhesive surface at the outer side and form a fourfold state as shown in FIG. 2 and then is closely stuck to the two planes (X3, Y3) in the three-plane crossing structure W3 in a form that the folded point edge part 6c is coincident or almost coincident to the point corner part D3 as well as the fourfold folded part 6b is coincident or almost coincident to the linear corner part A3 and the twofold folded part 6a1 is coincident or almost coincident to the linear corner part B3 and the twofold folded part 6a2 is coincident or almost coincident to the liner corner part C3 so that the pressure-sensitive adhesive surface exposed at the fourfold outer side 5d1 comes into contact with the plane X3 and the pressure-sensitive adhesive surface exposed at the fourfold outer side 5d2 comes into contact with the plane Y3. Thereafter, the release liner which protects the pressure-sensitive adhesive surface in an unstuck state is peeled off and then the pressure-sensitive adhesive surface in an unstuck state positioned at the fourfold inner side 5c is closely stuck to the other one plane Z3 in the three-plane crossing structure W3 with extending the surface from the linear corner parts B3 and C3 to the direction of the plane Z3, whereby waterproofing execution by means of the extensible waterproofing and airtight pressure-sensitive adhesive sheet can be applied to the convexo-concave three-plane crossing structure.

Thus, in the case that the waterproofing execution by means of the extensible waterproofing and airtight pressure-sensitive adhesive sheet is applied to the convexo-concave three-plane crossing structure, since one of the plane angles between respective planes is less than 180° and two exceed 180° in the convexo-concave three-plane crossing structure, it is important to stick the extensible waterproofing and airtight pressure-sensitive adhesive sheet to the peripheral part of the convexo-concave three-plane crossing structure so that the fourfold folded part in the extensible waterproofing and airtight pressure-sensitive adhesive sheet is coincident or almost coincident to the linear corner part where two planes come into contact with each other at a plane angle of less than 1800.

Still further, in the case that the waterproofing execution of a three-plane crossing structure by means of an extensible waterproofing and airtight pressure-sensitive adhesive sheet is conducted by applying the extensible waterproofing and airtight pressure-sensitive adhesive sheet 1 shown in FIGS. 1A, 1B, 1C and 2 to the three-plane crossing structure W4 as the all convex three-plane crossing structure shown in FIG. 6D, the extensible waterproofing and airtight pressure-sensitive adhesive sheet is first folded so as to expose the pressure-sensitive adhesive surface at the outer side and form a fourfold state as shown in FIG. 2 and then is closely stuck to any two planes of the three planes in the three-plane crossing structure W4 in a form that the folded point edge part 6c is coincident or almost coincident to the point corner part D4 as well as the fourfold folded part 6b is coincident or almost coincident to any linear corner part of the linear corner parts A4, B4, and C4 and the twofold folded part 6a1 and the twofold folded part 6a2 are coincident or almost coincident to the other liner corner parts, respectively so that the pressure-sensitive adhesive surface exposed at the fourfold outer side 5d1 and the pressure-sensitive adhesive surface exposed at the fourfold outer side 5d2 each comes into contact with any of the plane X4, the plane Y4, and the plane Z4. Thereafter, the release liner which protects the pressure-sensitive adhesive surface in an unstuck state is peeled off and then the pressure-sensitive adhesive surface in an unstuck state positioned at the fourfold inner side 5c is closely stuck to the other one plane in the three-plane crossing structure W4 with extending the surface from the linear corner parts, to which the twofold folded part 6a1 and the twofold folded part 6a2 each is coincident or almost coincident, to the direction of the plane which is not yet stuck, whereby waterproofing execution by means of the extensible waterproofing and airtight pressure-sensitive adhesive sheet can be applied to the all convex three-plane crossing structure.

Thus, in the case that the waterproofing execution by means of the extensible waterproofing and airtight pressure-sensitive adhesive sheet is applied to the all convex three-plane crossing structure, since all the plane angles between respective planes exceed 180° in the all convex three-plane crossing structure, the extensible waterproofing and airtight pressure-sensitive adhesive sheet may be stuck to the peripheral part of the all convex three-plane crossing structure so that the fourfold folded part in the extensible waterproofing and airtight pressure-sensitive adhesive sheet is coincident or almost coincident to any of the linear corner parts.

In the invention, at the time when the extensible waterproofing and airtight pressure-sensitive adhesive sheet is stuck to the peripheral part of the three-plane crossing structure, it is preferable that the extensible waterproofing and airtight pressure-sensitive adhesive sheet is first folded so as to expose the pressure-sensitive adhesive surface at the outer side and form a fourfold state, then the extensible waterproofing and airtight pressure-sensitive adhesive sheet folded so as to form a fourfold state and having a form that the pressure-sensitive adhesive surface positioned at the outer side is exposed is stuck on one line from the point corner part to the linear corner part of the three-plane crossing structure in a form that the folded edge part is coincident or almost coincident to the point corner part of the three-plane crossing structure and the fourfold folded part is coincident or almost coincident to any of the linear corner parts, thereafter the pressure-sensitive adhesive surfaces exposed at the fourfold outer side are closely stuck to two planes which form a linear corner part, to which a fourfold folded part is coincident or almost coincident, in a form that the twofold folded parts are coincident or almost coincident to the other liner corner parts, and finally the pressure-sensitive adhesive surface exposed at the fourfold inner side in an unstuck state is closely stuck to the other one plane with extending the surface from the linear corner parts, to which the twofold folded parts are coincident or almost coincident, to the direction of the other one plane.

In this connection, at the time when the pressure-sensitive adhesive surfaces at the fourfold outer side are stuck to the two planes which form a linear corner part to which a fourfold folded part is coincident or almost coincident, the extensible waterproofing and airtight pressure-sensitive adhesive sheet folded so as to form a fourfold state is preferably stuck without extension (in a form that an extension ratio of 0%) but may be stuck with only a slight extension (e.g., an extension ratio of 10% or less).

On the other hand, at the time when the pressure-sensitive adhesive surface at the fourfold inner side in the extensible waterproofing and airtight pressure-sensitive adhesive sheet folded so as to form a fourfold state is stuck to the other one plane, the sticking is conducted with extending the surface from the linear corner parts, to which the twofold folded parts are coincident or almost coincident, to the direction of the other one plane. The extension ratio at that time is not particularly limited but may be, for example, from 10 to 100%.

Therefore, the extensible waterproofing and airtight pressure-sensitive adhesive sheet is preferably a waterproofing and airtight pressure-sensitive adhesive sheet which is easily extensible and is difficult to shrink after extension. Specifically, for example, those having a large elongation at break and a small stress under 100% elongation can be suitably employed.

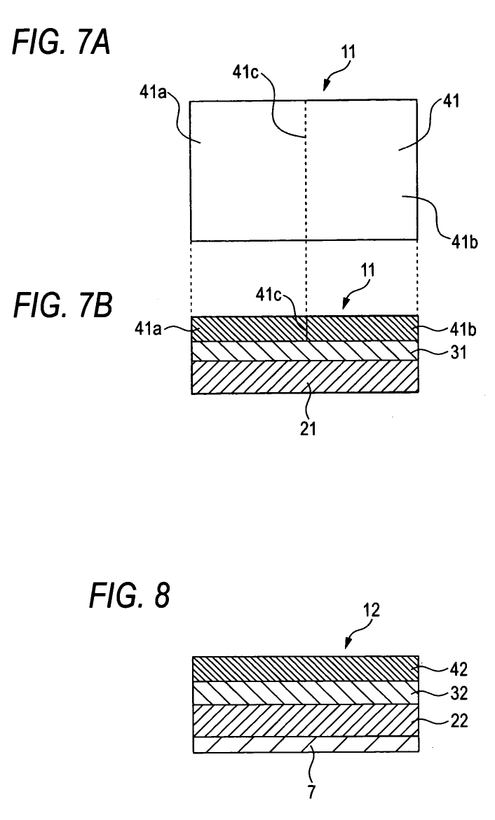

Moreover, at the time when the extensible waterproofing and airtight pressure-sensitive adhesive sheet is stuck to the peripheral part of the three-plane crossing structure, it is necessary to first fold the extensible waterproofing and airtight pressure-sensitive adhesive sheet in a form that the pressure-sensitive adhesive surface positioned at the outer side is exposed so as to from a fourfold state. For the purpose, the extensible waterproofing and airtight pressure-sensitive adhesive sheet is provided with a split in the back at a site of the release liner corresponding to the linear folded part at the time when the sheet is folded into two as shown in FIGS. 7A and 7B, so as to be able to peel off the release liner which protects the pressure-sensitive adhesive surface positioned toward the outer side at the time when the sheet is folded so as to form a fourfold state. Thus, when a split in the back is provided at a predetermined position of the release liner, the release liner which protects the pressure-sensitive adhesive surface positioned at the outer side at the time when the sheet is folded so as to form a fourfold state can be easily peeled off and thus workability in waterproofing execution of the three-plane crossing structure using the extensible waterproofing and airtight pressure-sensitive adhesive sheet can be improved.

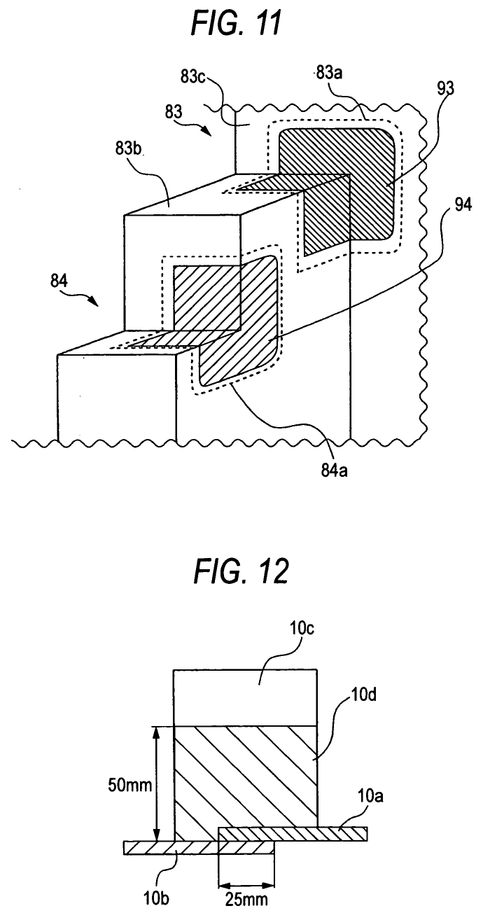

FIGS. 7A and 7B are schematic views to illustrating a part of an example of the extensible waterproofing and airtight pressure-sensitive adhesive sheet of the invention, FIG. 7A being a top view and FIG. 7B being a cross-sectional view. In FIGS. 7A and 7B, 11 is an extensible waterproofing and airtight pressure-sensitive adhesive sheet, 21 is a substrate, 31 is a pressure-sensitive adhesive layer, 41 is a release liner, 41a is a release liner part at one end part in the release liner 41, 41b is a release liner part at another end part in the release liner 41, and 41c is a split line in the back provided on the release liner 41. In the extensible waterproofing and airtight pressure-sensitive adhesive sheet 11, the release liner 41 is provided with a split line in the back 41c at the central part or almost central part between any opposed end parts and thereby the release liner part 41a and the release liner part 41b can be separately peeled off.

In this connection, in the invention, the extensible waterproofing and airtight pressure-sensitive adhesive sheet 11 as shown in FIGS. 7A and 7B is used as an extensible waterproofing and airtight pressure-sensitive adhesive sheet, it is important to fold the sheet into two so that the split line in the back-41c formed in the release liner 41 comes to the mountain at a mountain fold at the time when the sheet is folded so as to form a twofold state in Step (A).

[Extensible Waterproofing and Airtight Pressure-Sensitive Adhesive Sheet]

The extensible waterproofing and airtight pressure-sensitive adhesive sheet is not particularly limited as far as it is a pressure-sensitive adhesive sheet having a substrate, a pressure-sensitive adhesive layer formed on one side of the substrate, and a release liner which protects the surface of the pressure-sensitive adhesive layer (pressure-sensitive adhesive surface) and having extensibility as well as capable of imparting waterproofing properties and airtightness after sticking. As the extensible waterproofing and airtight pressure-sensitive adhesive sheet, it is important to have extensibility and it is preferable to have an excellent extensibility and properties difficult to shrink after extension. Specifically, the extensible waterproofing and airtight pressure-sensitive adhesive sheet preferably has such characteristic features that not only its elongation at break (distance between two gauge marks: 40 mm, drawing rate: 300 mm/min) is from 200 to 1,200% in both the longitudinal direction (MD direction) and the cross direction (TD direction), but also its stress under 100% elongation (distance between two gauge marks: 40 mm, drawing rate: 50 mm/min) is from 10 to 100 N/cm² in both the longitudinal direction (MD direction) and the cross direction (TD direction).

In the extensible waterproofing and airtight pressure-sensitive adhesive sheet, the elongation at break (distance between two gauge marks: 40 mm, drawing rate: 300 mm/min; sometimes referred to as “elongation in break”) is preferably from 200 to 1,200%, more preferably from 300 to 1200%, particularly from 500 to 1200% in both the longitudinal direction (lengthwise or machine direction, i.e., so-called “MD direction”) and the cross direction (transverse direction, i.e., so-called “TD direction”). Incidentally, when the elongation at break of the extensible waterproofing and airtight pressure-sensitive adhesive sheet is less than 200% in at least one direction of the MD direction and the TD direction, elongation properties in sticking the extensible waterproofing and airtight pressure-sensitive adhesive sheet are lowered; and on the other hand, when it exceeds 1,200%, cutting is liable to occur in elongating and sticking the extensible waterproofing and airtight pressure-sensitive adhesive sheet.

The elongation at break may be the same size or a different size in both the MD direction and the TD direction. With respect to the elongation at break, in many cases, the elongation at break in the TD direction is larger than that in the MD direction. For example, the elongation at break in the MD direction may be from 200 to 1,000% (preferably from 300 to 900%, and more preferably from 500 to 800%), whereas the elongation at break in the TD direction may be from 300 to 1,200% (preferably from 500 to 1,200%, and more preferably from 700 to 1,200%).

In the extensible waterproofing and airtight pressure-sensitive adhesive sheet, the elongation at break can be determined in such a manner that an extensible waterproofing and airtight pressure-sensitive adhesive sheet is punched into a specimen of a dumbbell shape No. 1 as defined in JIS K6251 (test width: 10 mm, distance between two gauge marks: 40 mm) in each of the longitudinal direction and the cross direction of the extensible waterproofing and airtight pressure-sensitive adhesive sheet; and using a tensile tester according to JIS Z0237, the crosshead side of the specimen is drawn at a rate of 300 mm/min under conditions of a distance between two gauge marks of the specimen of 40 mm and a width of the specimen (test width) of 10 mm, thereby measuring an elongation at the time when the specimen is broken.

Also, in the extensible waterproofing and airtight pressure-sensitive adhesive sheet, the stress under 100% elongation (distance between two gauge marks: 40 mm, drawing rate: 50 mm/min; hereinafter sometimes referred to as “100% tensile deforming stress”) is preferably from 10 to 100 N/cm², more preferably from 10 to 80 N/cm², particularly from 10 to 70 N/cm² in both the longitudinal direction (lengthwise or machine direction, i.e., so-called MD direction) and the cross direction (transverse direction, i.e., so-called TD direction). Incidentally, when the 100% tensile deforming stress of the extensible waterproofing and airtight pressure-sensitive adhesive sheet is less than 10 N/cm² in at least one direction of the MD direction and the TD direction, adhesion in sticking the extensible waterproofing and airtight pressure-sensitive adhesive sheet is lowered; and on the other hand, when it exceeds 100 N/cm², the generation of wrinkle, cutting, or peeling is liable to occur due to the deforming stress after elongating and sticking the extensible waterproofing and airtight pressure-sensitive adhesive sheet.

The 100% tensile deforming stress may be the same size or a different size in both the MD direction and the TD direction. With respect to the 100% tensile deforming stress, in many cases, the 100% tensile deforming stress in the MD direction is larger than that in the TD direction. For example, the 100% tensile deforming stress in the MD direction may be from 12 to 100 N/cm² (preferably from 15 to 80 N/cm², and more preferably from 20 to 70 N/cm²), whereas the 100% tensile deforming stress in the TD direction may be from 10 to 80 N/cm² (preferably from 10 to 50 N/cm², and more preferably from 10 to 30 N/cm²).

In the extensible waterproofing and airtight pressure-sensitive adhesive sheet, the 100% tensile deforming stress is a value calculated in such a manner that an extensible waterproofing and airtight pressure-sensitive adhesive sheet is punched into a specimen of a dumbbell shape No. 1 as defined in JIS K6251 (test width: 10 mm, distance between two gauge marks: 40 mm) in each of the longitudinal direction and the cross direction of the extensible waterproofing and airtight pressure-sensitive adhesive sheet; according to JIS K6254, by using a tensile tester, the crosshead side of the specimen is drawn at a rate of 50 mm/min under conditions of a distance between two gauge marks of the specimen of 40 mm and a width of the specimen (test width) of 10 mm, and when the specimen is drawn with 100%, the drawing is stopped at the time, thereby measuring a load at this time; and the measured load value is divided by a cross-sectional area of the specimen [(thickness of specimen)×(width of specimen)] before drawing.

In the extensible waterproofing and airtight pressure-sensitive adhesive sheet, the elongation at break and the 100% tensile deforming stress can be adjusted by controlling physical properties (for example, elongation at break and 100% tensile deforming stress) of the substrate and adhesive strength of the pressure-sensitive adhesive layer. For example, when a substrate having such characteristic features that not only its elongation at break (distance between two gauge marks: 40 mm, drawing rate: 300 mm/min) is from 200 to 1,200% in both the longitudinal direction and the cross direction but also its stress under 100% elongation (distance between two gauge marks: 40 mm, drawing rate: 50 mm/min) is from 10 to 100 N/cm² in both the longitudinal direction and the cross direction is used as the substrate, it is possible to prepare an extensible waterproofing and airtight pressure-sensitive adhesive sheet having the foregoing elongation at break and 100% tensile deforming stress. Incidentally, the elongation at break and 100% tensile deforming stress of the substrate can be measured in the same manner as in the elongation at break and 100% tensile deforming stress of the extensible waterproofing and airtight pressure-sensitive adhesive sheet.

(Substrate)

The substrate is not particularly limited as far as it is a substrate capable of preparation of an extensible waterproofing and airtight pressure-sensitive adhesive sheet but a rubber-made sheet can be suitably used. The raw material or material of the rubber-made sheet is not particularly limited, and various rubber compositions (for example, rubber compositions containing a synthetic rubber or a natural rubber) can be used. It is preferable that the rubber-made sheet is constituted of a rubber composition containing a synthetic rubber as the main component. Such a synthetic rubber is not particularly limited, and examples thereof include a butyl rubber, a polyisoprene rubber, a polyisobutylene rubber, a chloroprene rubber, a nitrile butyl rubber, an ethylene-propylene rubber (EPT), an ethylene-propylene-diene rubber (EPDM), a polybutene rubber, a chlorinated polyethylene rubber, a styrene-butadiene (SB) rubber, a styrene-isoprene (SI) rubber, a styrene-isoprene-styrene block copolymer (SIS) rubber, a styrene-butadiene-styrene block copolymer (SBS) rubber, a styrene-ethylene-butylene-styrene block copolymer (SEBS) rubber, a styrene-ethylene-propylene-styrene block copolymer (SEPS) rubber, and a styrene-ethylene-propylene block copolymer (SEP) rubber. The synthetic rubber can be used singly or in combinations of two or more thereof.

A butyl rubber, an ethylene-propylene rubber, and an ethylene-propylene-diene rubber can be suitably used as the synthetic rubber. Of these, a butyl rubber is especially preferable.

Besides the rubber component (e.g., a synthetic rubber), adequate additives such as a softener, a filler, a colorant, an ultraviolet absorber, an antioxidant, and an antistatic agent may be blended in proper amounts in the rubber composition.

Incidentally, a rubber-made sheet made of an un-vulcanized rubber is suitable as the rubber-made sheet from the standpoint that the physical properties (e.g., elongation at break and 100% tensile deforming stress) of the extensible pressure-sensitive adhesive sheet fall within the foregoing respective ranges.

The substrate such as the rubber-made sheet can be prepared by applying known forming methods (for example, an extrusion molding method and a calender molding method).

The thickness of the substrate (especially, the rubber-made sheet) is not particularly limited and for example, can be selected within the range of 0.1 mm or more (for example, from 0.1 to 3.0 mm), and preferably from 0.4 to 2.0 mm (more preferably from 0.5 to 1.5 mm). When the thickness of the substrate (especially, the rubber-made sheet) is too thin, the resulting pressure-sensitive adhesive sheet becomes weak against an impact; and on the other hand, when it is too thick, a force necessary for drawing the extensible waterproofing and airtight pressure-sensitive adhesive sheet becomes large.

In this connection, as the substrate, substrates having characteristic features that the elongation at break (distance between two gauge marks: 40 mm, drawing rate: 300 mm/min) is from 200 to 1,200% in both the MD direction and the TD direction, and the stress under 100% elongation (distance between two gauge marks: 40 mm, drawing rate: 50 mm/min) is from 10 to 100 N/cm² in both the MD direction and the TD direction (particularly rubber-made sheets) can be preferably used.

(Pressure-Sensitive Adhesive Layer)

The pressure-sensitive adhesive that constitutes the pressure-sensitive adhesive layer is not particularly limited, and examples thereof include known pressure-sensitive adhesives such as rubber-based pressure-sensitive adhesives, acrylic pressure-sensitive adhesives, polyester-based pressure-sensitive adhesives, urethane-based pressure-sensitive adhesives, polyamide-based pressure-sensitive adhesives, epoxy-based pressure-sensitive adhesives, vinyl alkyl ether-based pressure-sensitive adhesives, silicone-based pressure-sensitive adhesives, and fluorine-based pressure-sensitive adhesives. Also, the pressure-sensitive adhesive may be a hot melt type pressure-sensitive adhesive. The pressure-sensitive adhesive can be used singly or in combinations of two or more thereof. The pressure-sensitive adhesive may be in the form of any pressure-sensitive adhesive such as an emulsion-based pressure-sensitive adhesive, a solvent-based pressure-sensitive adhesive, an oligomer-based pressure-sensitive adhesive, and a solid pressure-sensitive adhesive.

Incidentally, the pressure-sensitive adhesive may contain proper additives such as a crosslinking agent (e.g., a polyisocyanate-based crosslinking agent and an alkyl etherified melamine compound-based crosslinking agent), a tackifier (e.g., a rosin derivative resin, a polyterpene resin, a petroleum resin, and a phenol resin), a plasticizer, a filler, and an anti-aging agent in addition to the polymer component such as the pressure-sensitive adhesive component (base polymer) depending upon the kind of the pressure-sensitive adhesive.

A rubber-based pressure-sensitive adhesive is suitable as the pressure-sensitive adhesive. For example, the rubber-based pressure-sensitive adhesive may be any of a natural rubber-based pressure-sensitive adhesive containing a natural rubber as the base polymer or a synthetic rubber-based pressure-sensitive adhesive containing a synthetic rubber as the base polymer. Of these, a synthetic rubber-based pressure-sensitive adhesive is preferable. Examples of synthetic rubbers in such a synthetic rubber-based pressure-sensitive adhesive include a butyl rubber, a polyisoprene rubber, a polyisobutylene rubber, a styrene-butadiene (SB) rubber, a styrene-isoprene (SI) rubber, a styrene-isoprene-styrene block copolymer (SIS) rubber, a styrene-butadiene-styrene block copolymer (SBS) rubber, a styrene-ethylene-butylene-styrene block copolymer (SEBS) rubber, a styrene-ethylene-propylene-styrene block copolymer (SEPS) rubber, a styrene-ethylene-propylene block copolymer (SEP) rubber, a regenerated rubber, and modified materials thereof. Of these, a butyl rubber is especially preferable. That is, a butyl rubber-based pressure-sensitive adhesive is most suitable as the pressure-sensitive adhesive.

As the method of forming a pressure-sensitive adhesive layer, known or customary forming methods can be employed, and a method of molding a pressure-sensitive adhesive into a sheet-like form by an extruder or a calender roll and sticking it onto a rubber-made sheet can be suitably employed. Also, a method of applying a pressure-sensitive adhesive on the surface of a substrate such as a rubber-made sheet (coating method) and a method of applying a pressure-sensitive adhesive on a release film such as a release liner to form a pressure-sensitive adhesive layer and then transferring the pressure-sensitive adhesive layer onto a substrate such as a rubber-made sheet (transfer method) can be employed.

The thickness of the pressure-sensitive adhesive layer is not particularly limited and for example, can be selected from the range of from 0.1 to 3 mm (preferably from 0.2 to 2 mm, and more preferably from 0.3 to 1 mm).

(Release Liner)

The release liner (separator) in the extensible waterproofing and airtight pressure-sensitive adhesive sheet is not particularly limited, and known release liners can be properly selected and used. Specifically, as the release liner, for example, use can be made of, in addition to the release liners having a release treatment layer treated with a release treatment agent at least one surface of a substrate, release liners from low adhesive substrates composed of fluorine-based polymers (e.g., polytetrafluoroethylene, polychlorotrifluoroethylene, polyvinyl fluoride, polyvinylidene fluoride, tetrafluoroethylene-hexafluoropropylene copolymers, chlorofluoroethylene-vinylidene fluoride copolymers, etc.), low adhesive substrates composed of non-polar polymers (e.g., olefinic resins such as polyethylene and polypropylene, etc.), and the like. As the release liner, for example, release liners having a form that a release treatment layer is formed on at least one surface of the substrate can be suitably employed. In such release liners, as the substrate on which a release treatment layer is formed, there may be mentioned plastic base films (synthetic resin films) such as polyester films (polyethylene terephthalate film etc.), olefinic resin films (polyethylene film, polypropylene film, etc.), polyvinyl chloride film, polyimide films, polyamide films (Nylon film), fluorinated films (polytetrafluoroethylene film, etc.) and rayon films, and papers (wood free paper, Japanese paper, kraft paper, glassine paper, synthetic paper, top coat paper, etc.), as well as multilayered ones (complexes having two or three layers) thereof by lamination or co-extrusion and the like.

On the other hand, the release treatment agent constituting the release treatment layer is not particularly limited and, for example, use can be made of silicone release treatment agents, fluorinated release treatment agents, long-chain alkyl release treatment agents, and the like. The release treatment agent may be used singly or in combination of two or more thereof.

The release treatment layer can be formed by applying a release treatment agent on a predetermined surface (at least one surface) of a substrate, followed by a heating step for drying and curing. In this connection, known or customary heating methods (e.g., a method of using a hot air dryer and the like method) can be utilized in the heating step for drying and curing.

Incidentally, the thickness of the release liner, the thickness of the substrate in the release liner, the thickness of the release treatment layer, and the like are not particularly limited and may be suitably selected.

In the invention, as the release liner, it is preferable that a split line in the back is provided at the central part (particularly, at the central part in the cross direction) between opposed end parts. The split line in the back may be any form of split lines in the back, e.g., a linear split line in the back an a dotted split line in the back. In this connection, in the case that a linear split line in the back is formed, the release liner may be separated at the both sides of the split line in the back.

The split line in the back may be formed beforehand prior to the sticking of the release liner to the pressure-sensitive adhesive layer or may be formed after the sticking to the pressure-sensitive adhesive layer. In this connection, for example, when the split line in the back is formed prior to the sticking of the release liner to the pressure-sensitive adhesive layer in the case that a linear prior to the sticking of the release liner to the pressure-sensitive adhesive layer is provided on the release liner stuck to the pressure-sensitive adhesive layer, the sheet may have a constitution that one sheet of the release liner is provided with a split line in the back and then is stuck to the pressure-sensitive adhesive layer or may have a constitution that two sheets of the release liner are stuck to the pressure-sensitive adhesive layer.

The method of forming the split line in the back is not particularly limited and, for example, there may be mentioned a method of forming the split line in the back by means of a cutting tool such as a cutter blade or a round blade. In this connection, the position of the split line in the back is desirably at the central part in the direction of the cross direction of the sheet but may be a position deviated from the central part to a little to the right or left (a little to the end part of the cross direction). Moreover, the depth and width of the split line in the back are also not particularly limited.

(Non-Self-Adhesive and Non-Releasing Film Layer)

In the invention, since the extensible waterproofing and airtight pressure-sensitive adhesive sheet is used with folding it in a form that its back side is positioned each other in an opposed manner toward the inner side and the pressure-sensitive adhesive surface is positioned toward the outer side so as to form a twofold state, it is preferable to have properties not self-adhesive (non-self-adhesive properties) even when the back side come into contact with each other. In particular, in the case that a rubber-made sheet is used as the substrate of the extensible waterproofing and airtight pressure-sensitive adhesive sheet, it is important that the back side of the extensible waterproofing and airtight pressure-sensitive adhesive sheet (i.e., surface of the rubber-made sheet) has non-self-adhesive properties.

Moreover, there is a case that, after the extensible waterproofing and airtight pressure-sensitive adhesive sheet is stuck to the peripheral part of three-plane crossing in three-plane crossing structure, in order to apply waterproofing execution in an range wider than the range, the same extensible waterproofing and airtight pressure-sensitive adhesive sheet or the other waterproofing and airtight pressure-sensitive adhesive sheet (this waterproofing and airtight pressure-sensitive adhesive sheet may have extensibility or may not have extensibility) is stuck on the extensible waterproofing and airtight pressure-sensitive adhesive sheet. For the purpose, the extensible waterproofing and airtight pressure-sensitive adhesive sheet preferably has adhesive properties to the pressure-sensitive adhesive layers in various waterproofing and airtight pressure-sensitive adhesive sheets [pressure-sensitive adhesive layer-adhesive properties (non-releasing properties)].

Therefore, as the extensible waterproofing and airtight pressure-sensitive adhesive sheet, the back side suitably has non-self-adhesive properties and pressure-sensitive adhesive layer-adhesive properties (non-releasing properties). Thus, in order to impart non-self-adhesive properties and pressure-sensitive adhesive layer-adhesive properties (non-releasing properties)- to the back side of the extensible waterproofing and airtight pressure-sensitive adhesive sheet, a film layer having non-self-adhesive properties and pressure-sensitive adhesive layer-adhesive properties (non-releasing properties) (sometimes referred to as “non-self-adhesive and non-releasing film layer”) can be formed on the surface of the substrate (particularly, rubber-made sheet). Therefore, the extensible waterproofing and airtight pressure-sensitive adhesive sheet preferably has a constitution that a pressure-sensitive adhesive layer is formed on one surface of the rubber-made sheet as the substrate and a film layer having non-self-adhesive properties and pressure-sensitive adhesive layer-adhesive properties (non-self-adhesive and non-releasing film layer) is formed on the other surface (surface opposite to the pressure-sensitive adhesive layer, i.e., back side) of the rubber-made sheet, as shown in FIG. 8.

FIG. 8 is a schematic cross-sectional view illustrating a part of an example of the extensible waterproofing and airtight pressure-sensitive adhesive sheet of the invention. In FIG. 8, 12 is an extensible waterproofing and airtight pressure-sensitive adhesive sheet, 22 is a rubber-made sheet, 32 is a pressure-sensitive adhesive layer, 42 is a release liner, and 7 is a film layer having pressure-sensitive adhesive layer-adhesive properties (non-self-adhesive and non-releasing film layer). The extensible waterproofing and airtight pressure-sensitive adhesive sheet 12 shown in FIG. 8 has a constitution that the pressure-sensitive adhesive layer 32 is formed on one surface of the rubber-made sheet 22, a non-self-adhesive and non-releasing film layer 7 is formed on another surface, and the pressure-sensitive adhesive layer 32 is protected with the release liner 42.

The non-self-adhesive and non-releasing film layer is a film layer having non-self-adhesive properties and pressure-sensitive adhesive layer-adhesive properties (non-releasing properties), and the kind of its film forming composition (raw material or material) is not particularly limited as far as it can exhibit non-self-adhesive properties and non-releasing properties. The non-self-adhesive and non-releasing film layer can be formed of, for example, a film forming composition containing an acrylic polymer or a long-chain alkyl-based compound, or a film forming composition containing components (for example, monomer components) to be used in preparing an acrylic polymer or a long-chain alkyl-based compound. The film forming composition for forming a non-self-adhesive and non-releasing film layer can be used singly or in combinations of two or more thereof.

As the above acrylic polymer, alkyl (meth)acrylate-based polymers containing at least an alkyl (meth)acrylate as a monomer component are suitable. Specific examples of the alkyl (meth)acrylate include C₁-₂₀-alkyl (meth)acrylates such as methyl (meth)acrylate, ethyl (meth)acrylate, propyl (meth)acrylate, isopropyl (meth)acrylate, n-butyl (meth)acrylate, isobutyl (meth)acrylate, sec-butyl (meth)acrylate, t-butyl (meth) acrylate, pentyl (meth) acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth) acrylate, undecyl (meth) acrylate, dodecyl (meth)acrylate, tridecyl (meth) acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. The alkyl (meth)acrylate as a monomer component can be used singly or in combinations of two or more thereof.

Also, in the acrylic polymer, a monomer component having copolymerization properties against the alkyl (meth)acrylate (copolymerizable monomer component) may be used along with the alkyl (meth)acrylate as monomer components. Examples of such a copolymerizable monomer component include carboxyl group-containing monomers such as (meth)acrylic acid (e.g., acrylic acid and methacrylic acid), itaconic acid, maleic acid, fumaric acid, crotonic acid, and isocrotonic acid, and anhydrides thereof (e.g., maleic anhydride and itaconic anhydride); maleic (mono- or di)esters such as monomethyl maleate, monoethyl maleate, and diethyl maleate; fumaric (mono- or di)esters such as monomethyl fumarate and monoethyl fumarate; aromatic vinyl compounds such as styrene and substituted styrenes; hydroxyl group-containing monomers such as hydroxyalkyl (meth) acrylates (e.g., hydroxyethyl (meth)acrylate and hydroxypropyl (meth)acrylate) and glycerin dimethacrylate; epoxy group-containing monomers such as glycidyl (meth)acrylate and methylglycidyl (meth)acrylate; cyano group-containing monomers such as acrylonitrile and methacrylonitrile; amide group-containing monomers such as acrylamide, methacrylamide, N-vinylpyrrolidone, and N,N-dimethyl (meth)acrylamide; amino group-containing monomers such as aminoethyl (meth) acrylate and (meth)acryloyl morpholine; imido group-containing monomers such as cyclohexyl maleimide and isopropyl maleimide; vinyl esters such as vinyl acetate; vinyl alcohols such as vinyl alcohol; vinyl ethers such as vinyl alkyl ethers; vinyl chloride; olefins such as ethylene and propylene; dienes such as butadiene, isoprene, and isobutylene; and sulfonic group-containing monomers such as sodium vinylsulfonate. The copolymerizable monomer component can be used singly or in combinations of two or more thereof.

Concretely, polybutyl methacrylate and an octadecyl methacrylate-acrylonitrile copolymer are suitable as the acrylic polymer.

On the other hand, the long-chain alkyl-based compound is not particularly limited, and for example, reaction products between polyvinyl alcohol and a long-chain alkylene isocyanate having from 10 to 20 carbon atoms such as stearyl isocyanate can be used.

In general, materials that are used as a release treatment agent are included in the material to be used in the non-self-adhesive and non-releasing film layer. However, in the invention, by properly selecting a combination with a pressure-sensitive adhesive (for example, a butyl rubber-based pressure-sensitive adhesive exhibits adhesive properties to a film layer made of an octadecyl methacrylate-acrylonitrile copolymer), or by making the coating amount thin, thereby generating a crack in a film layer in drawing an extensible waterproofing and airtight pressure-sensitive adhesive sheet at the time of sticking to reveal adhesive properties to the pressure-sensitive adhesive layer, it is possible to utilize a film layer made of a general release treatment agent as the non-self-adhesive and non-releasing film layer.

Incidentally, what the above film layer has adhesive properties to the pressure-sensitive adhesive layer means that, for example, with respect to two specimens prepared from the same pressure-sensitive adhesive sheet, in the case that a pressure-sensitive adhesive layer of one of the specimens is stuck onto the back side of a substrate of the other specimen (the film layer side) by reciprocating a 2-kg roll one time, and after elapsing for 30 minutes, a 180′-peel adhesive strength (width of specimen: 25 mm, drawing rate: 300 mm/min, temperature: 23±2° C., humidity: 50±5% RH) is measured, the 180°-peel adhesive strength is 3 N/25 mm or more (preferably 5 N/25 mm or more).

In the non-self-adhesive and non-releasing film layer, besides the acrylic polymer or long-chain alkyl-based compound, or the components for preparing an acrylic polymer or a long-chain alkyl-based compound (e.g., monomer components), adequate additives such as a filler, a colorant, an ultraviolet absorber, an antioxidant, and an antistatic agent may be blended in proper amounts in the film forming composition.

The method of forming a non-self-adhesive and non-releasing film layer is not particularly limited. For example, the non-self-adhesive and non-releasing film layer can be formed by coating the film forming composition on the back side of the substrate, followed by drying and curing, if desired. Incidentally, the foregoing film forming composition may be in the liquid state or molten state. In the case that the film forming composition is in the liquid state or molten state or contains monomer components for preparing an acrylic polymer, the non-self-adhesive and non-releasing film layer can be formed by drying and curing upon heating of the film forming composition after coating.

The thickness of the non-self-adhesive and non-releasing film layer is not particularly limited and for example, can be selected from the range of 0.5 to 10 μm, preferably from 1 to 5 μm, and about 3 μm in average.

Therefore, as the extensible waterproofing and airtight pressure-sensitive adhesive sheet, particularly suitable is one wherein a rubber-made sheet is used as a substrate, a pressure-sensitive adhesive layer is present on one surface of the rubber-made sheet, and a non-self-adhesive and non-releasing film layer is formed on the surface opposite to the pressure-sensitive adhesive layer (back side) of the substrate and which has an elongation at break (distance between two gauge marks: 40 mm, drawing rate: 300 mm/min) of 200 to 1200% in both the longitudinal direction (MD direction) and the cross direction (TD direction) and a stress under 100% elongation (distance between two gauge marks: 40 mm, drawing rate: 50 mm/min) of 10 to 100 N/cm² in both the longitudinal direction (TD direction) and the cross direction (MD direction).

The method for producing the extensible waterproofing and airtight pressure-sensitive adhesive sheet in the invention is not particularly limited. For example, in the case that a rubber-made sheet is used as a substrate and a non-self-adhesive and non-releasing film layer is formed on the surface opposite to the pressure-sensitive adhesive layer (back side) of the rubber-made sheet, the waterproofing and airtight pressure-sensitive adhesive sheet can be prepared by blending a rubber component such as a synthetic rubber with proper amounts of additives such as a softener and a filler; mixing the blend by a mixer such as a mixing roll, a kneader, and a Banbury mixer to prepare a rubber composition; molding the rubber composition into a sheet-like form using a calender roll, an extruder, or the like to prepare a rubber-made sheet; applying a film-forming composition on a predetermined side (side which will become the back side against a pressure-sensitive adhesive layer) of the rubber-made sheet by using a metal roll or in a casting method, and drying it to form a non-self-adhesive and non-releasing film layer; sticking a pressure-sensitive adhesive layer in the sheet-like form obtained by extrusion molding using an extruder or molding using a calender roll onto the other side (side which will become an adhesive side) of the rubber-made sheet; and further overlaying a release liner, one side or both sides of which become a releasing surface, on the surface of the pressure-sensitive adhesive layer and winding up the assembly.

Incidentally, in the case that the non-self-adhesive and non-releasing film layer is formed of polybutyl methacrylate, for example, the non-self-adhesive and non-releasing film layer can be formed by coating a solution of polybutyl methacrylate obtained by dissolving polybutyl methacrylate in a solvent such as xylene on the back side of a substrate, followed by drying.

Also, in the case that the pressure-sensitive adhesive layer is a pressure-sensitive adhesive layer made of a rubber-based pressure-sensitive adhesive, for example, the pressure-sensitive adhesive layer in the sheet-like form can be formed by adding proper amounts of additives such as a softener, a filler, and a tackifier to a rubber component such as a butyl rubber and mixing them in a mixer (for example, a mixing roll and a kneader) to prepare a rubber-based pressure-sensitive adhesive (in particular, a butyl rubber-based pressure-sensitive adhesive) and molding the rubber-based pressure-sensitive adhesive using an extruder or a calender roll. As a matter of course, as described previously, the pressure-sensitive adhesive layer can be formed by coating a pressure-sensitive adhesive composition in the solution state or molten state on the predetermined surface of a rubber-made sheet, or by coating it on a release film and then transferring it onto the predetermined side of a rubber-made sheet.

Moreover, it is important to use, as the rubber-made sheet, a rubber-made sheet having physical properties (e.g., elongation at break and 100% tensile deforming stress) so as to enable the elongation at break and 100% tensile deforming stress of the extensible waterproofing and airtight pressure-sensitive adhesive sheet to fall within the foregoing respective ranges.

In the waterproofing execution method of a three-plane crossing structure, since an extensible waterproofing and airtight pressure-sensitive adhesive sheet is stuck to the peripheral part of three-plane crossing including a point corner part which comes into contact with three planes in a three-plane crossing structure and peripheral parts thereof, the waterproofing and airtight pressure-sensitive adhesive sheet can be closely stuck effectively and easily even to the peripheral part of three-plane crossing and hence waterproofing execution can be applied with an excellent waterproofing properties and air-tight properties.

In particular, when the extensible waterproofing and airtight pressure-sensitive adhesive sheet has an elongation at break (distance between two gauge marks: 40 mm, drawing rate: 300 mm/min) of 200 to 1200% in both the longitudinal direction and the cross direction and a stress under 100% elongation (distance between two gauge marks: 40 mm, drawing rate: 50 mm/min) of 10 to 100 N/cm² in both the longitudinal direction and the cross direction, not only it is possible to stick the waterproofing and airtight pressure-sensitive adhesive sheet by properly drawing it, but also, even when the sheet is stuck in an elongated state, wrinkle, break, and peeling are prevented and thus it is possible to effectively keep that state over a long period of time.

Moreover, in the case that the extensible waterproofing and airtight pressure-sensitive adhesive sheet is formed using a rubber-made sheet as the substrate, by forming a non-self-adhesive and non-releasing film layer on the surface (back side) of the rubber-made sheet as a substrate, the adhesion or self-adhesion of the back side can be prevented even when the back side of the substrate comes into contact with each other and also each pressure-sensitive adhesive layer of various pressure-sensitive adhesive sheets % e.g., the same or different extensible waterproofing and airtight pressure-sensitive adhesive sheets, non-extensible waterproofing and airtight pressure-sensitive adhesive sheets, etc.) can be well adhered to the back side. Therefore, even when any of various pressure-sensitive adhesive sheets are overlapped and stuck to the extensible waterproofing and airtight pressure-sensitive adhesive sheet, the adhesive properties of various pressure-sensitive adhesive sheets (e.g., the same or different extensible waterproofing and airtight pressure-sensitive adhesive sheets, non-extensible waterproofing and airtight pressure-sensitive adhesive sheets, etc.) can be effectively secured and it becomes possible to apply waterproofing execution with excellent waterproofing properties and airtightness over the whole three-plane crossing structure.

The three-plane crossing structure to which the waterproofing execution method of a three-plane crossing structure in the invention is applied is not particularly limited as far as it is a three-plane crossing structure having the three planes wherein the three planes come into contact and respective planes of the three planes also come into contact with each other, but there may be mentioned dwelling house exterior underlying structures where the exterior is in an underlying state. As the peripheral part of three-plane crossing including a point corner part which comes into contact with three planes in a three-plane crossing structure and peripheral parts thereof, there may be, for example, mentioned various internal corner parts and external corner parts in dwelling house exterior underlying structures such as ventilation fan frames, sash flames, junction parts between handrail parts and wall parts, level difference parts of stepwise handrail parts, and skylight-attaching parts in dwelling house exterior underlying structures, and the like. Accordingly, the waterproofing execution method of a three-plane crossing structure according to the invention can be suitably applied at the time when waterproofing execution is applied to dwelling house exterior underlying structures. Therefore, it is possible to enhance waterproofing properties and airtightness of dwelling houses and also, it is possible to prevent penetration of storm sewage into the inner sides of dwelling houses and to prevent dew condensation and corrosion in the inner sides of dwelling houses.

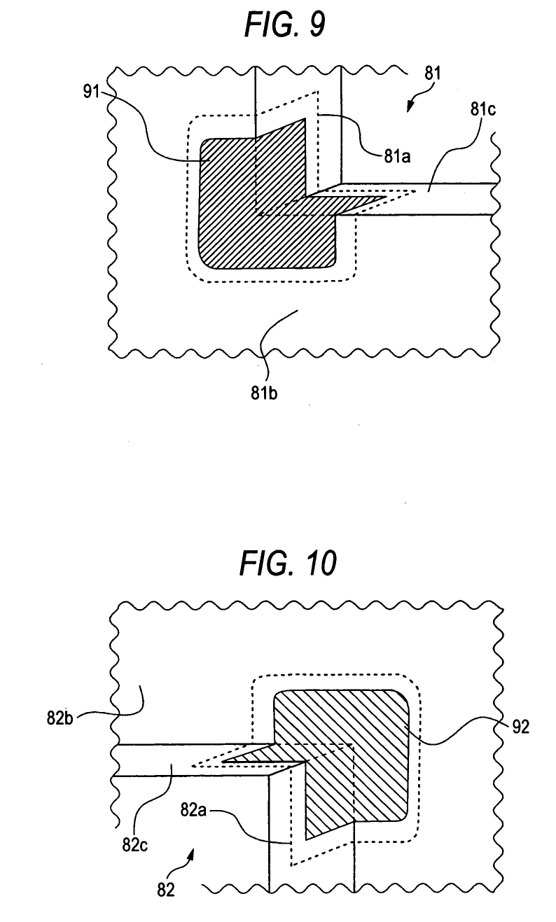

Incidentally, FIGS. 9 to 11 show specific examples of applying waterproofing execution to the peripheral parts in three-plane crossing structures utilize the waterproofing execution method of a three-plane crossing structure of the invention. FIGS. 9 to 11 each is a schematic view illustrating an example of applying waterproofing execution to a peripheral part of three-plane crossing in a three-plane crossing structure. In FIG. 9, 81 is a sash frame in dwelling house exterior underlying structure, 81a is a peripheral part of three-plane crossing including a point corner part wherein three planes come into contact with each other and peripheral part thereof in the sash frame 81, 81b is an outer wall part, 81c is a sash insert part, and 91 is an extensible waterproofing and airtight pressure-sensitive adhesive sheet stuck to peripheral part of three-plane crossing 81a.

Moreover, in FIG. 10, 82 is a ventilating fan frame in dwelling house exterior underlying structure, 82a is a peripheral part of three-plane crossing including a point corner part wherein three planes come into contact with each other and peripheral part thereof in the ventilating fan frame 82, 82b is an outer wall part, 82c is a ventilating fan insert part, and 92 is an extensible waterproofing and airtight pressure-sensitive adhesive sheet stuck to peripheral part of three-plane crossing 82a.

Furthermore, in FIG. 11, 83 is a junction part between handrail part and wall part in dwelling house exterior underlying structure, 83a is a peripheral part of three-plane crossing including a point corner part wherein three planes come into contact with each other and peripheral part thereof in the junction part between the handrail part and the wall part 83, 83b is a handrail wall part, 83c is a wall part, 84 is a level difference part of stepwise handrail part in dwelling house exterior underlying structure, 84a is a peripheral part of three-plane crossing including a point corner part wherein three planes come into contact with each other and peripheral part thereof in level difference part of the stepwise handrail part 84, 93 is an extensible waterproofing and airtight pressure-sensitive adhesive sheet stuck to peripheral part of three-plane crossing 83a, and 94 is an extensible waterproofing and airtight pressure-sensitive adhesive sheet stuck to peripheral part of three-plane crossing 84a.

The invention will be described below in more detail with reference to the following Examples, but it should be construed that the invention is not limited thereto.

(Preparation Example 1 of Extensible Waterproofing and Airtight Pressure-Sensitive Adhesive Sheet)

A predetermined amount of the film forming composition obtained in Preparation Example 1 of Film Forming Composition to be described below was coated on one side of the rubber-made sheet having a thickness of 0.45 mm obtained in Preparation Example 1 of Substrate to be described below and dried at 100° C. for 0.5 minutes to form a film layer having a thickness of about 3 μm. Thereafter, the pressure-sensitive adhesive layer in the sheet-like form (thickness: 1.0 mm) obtained in Preparation Example 1 of Pressure-sensitive Adhesive Layer to be described below was stuck on the other side of the rubber-made sheet (the side opposite to the film layer), and a release liner, one side of which had been subjected to a silicone release treatment, was stuck on the pressure-sensitive adhesive layer to obtain an extensible waterproofing and airtight pressure-sensitive adhesive sheet.

(Preparation Example 1 of Substrate)

50 parts by weight of a butyl rubber, 50 parts by weight of an ethylene-propylene-diene rubber (EPDM), 120 parts by weight of calcium carbonate heavy, 15 parts by weight of a process oil, and 10 parts by weight of carbon black were charged into a mixer (Banbury mixer) and kneaded for 8 minutes. The kneaded mixture was then molded into a sheet-like form using a calender roll under a condition at a roll temperature of 110° C. There were thus prepared rubber-made sheets having a varied thickness (a rubber-made sheet having a thickness of 0.45 mm, a rubber-made sheet having a thickness of 0.55 mm, and a rubber-made sheet having a thickness of 2.0 mm).

(Preparation Example 1 of Film Forming Composition)

Acrylonitrile and octadecyl methacrylate were polymerized in a toluene solution to obtain a copolymer [acrylonitrile/octadecyl methacrylate (weight molar ratio)=30/70, weight average molecular weight: 40,000). This copolymer was subjected to concentration adjustment with toluene to prepare a solution having a solid content of 1% by weight. This solution was designated as a film forming composition.

(Preparation Example 1 of Pressure-sensitive Adhesive Layer)

A mixture of 100 parts by weight of a butyl rubber, 50 parts by weight of a tackifier, 100 parts by weight of calcium carbonate heavy, 30 parts by weight of carbon black, and 100 parts by weight of a softener was introduced into an extruder and extrusion molded to prepare a pressure-sensitive adhesive layer in the sheet-like form having a thickness of 1.0 mm.

In this connection, the elongation at break (distance between two gauge marks: 40 mm, drawing rate: 300 mm/min) in the extensible waterproofing and airtight pressure-sensitive adhesive sheet prepared by Preparation Example 1 of Extensible Waterproofing and Airtight Pressure-Sensitive Adhesive Sheet was 690% in the longitudinal direction and 970% in the cross direction. Moreover, the stress under 100% elongation (distance between two gauge marks: 40 mm, drawing rate: 50 mm/min) in the above extensible waterproofing and airtight pressure-sensitive adhesive sheet was 50 N/cm² in the longitudinal direction and 20 N/cm² in the cross direction. In this connection, the elongation at break and the stress under 100% elongation in the extensible waterproofing and airtight pressure-sensitive adhesive sheet were measured by the method of measuring an elongation at break and the method of measuring a stress under 100% elongation to be described below.

(Method of Measuring Elongation at Break)

The extensible waterproofing and airtight pressure-sensitive adhesive sheet is punched into a specimen of a dumbbell shape No. 1 as defined in JIS K6251 (test width: 10 mm, distance between two gauge marks: 40 mm) in each of the longitudinal direction (MD direction) and the cross direction (TD direction) of the specimen; and using a tensile tester, the crosshead side of the specimen is drawn at a rate of 300 mm/min under conditions of a distance between two gauge marks of the specimen of 40 mm and a width of the specimen of 10 mm, thereby measuring an elongation (%) at the time when the specimen is broken.

(Method of Measuring Stress under 100% Elongation)

The extensible waterproofing and airtight pressure-sensitive adhesive sheet is punched into a specimen of a dumbbell shape No. 1 as defined in JIS K6251 (test width: 10 mm, distance between two gauge marks: 40 mm) in each of the longitudinal direction (MD direction) and the cross direction (TD direction) of the specimen; in accordance to JIS K6254 using a tensile tester, the crosshead side of the specimen is drawn at a rate of 50 mm/min under conditions of a distance between two gauge marks of the specimen of 40 mm and a width of the specimen of 10 mm; and when the specimen was drawn with 100%, the drawing is stopped at the time, thereby measuring a load (N) at this time; and the measured load value was divided by a cross-sectional area of the specimen [(thickness of specimen)ₓ(width of specimen)] before drawing to calculate load per unit cross-sectional area (N/cm²), the calculated value being designated as a stress under 100% elongation.

(Evaluation of Adhesive Properties of Back Side)

The pressure-sensitive adhesive sheet obtained in the above Preparation Example 1 of Extensible Waterproofing and Airtight Pressure-Sensitive Adhesive Sheet was cut into a width of 25 mm, and adhesive properties of the back side of the substrate (the side of the film layer made of the film forming composition obtained in Preparation Example 1 of Film Forming Composition) were confirmed through finger touch. Also, the back sides (film layer sides) were stuck to each other and laminated by reciprocating a 2-kg roll one time, and after elapsing for 30 minutes, the laminate was peeled apart from each other to confirm organoleptically adhesive properties between the back sides. Moreover, in this peeling, a 180′-peel adhesive strength (width of specimen: 25 mm, drawing rate: 300 mm/min, temperature: 23±2° C., humidity: 50±5% RH) was measured. As a result, no tackiness was felt through finger touch, and in peeling after sticking the back sides to each other, the 180′-peel adhesive strength was 0 N/25 mm. Thus, it was confirmed that the back sides did not cause adhesion to each other so that the sticking application work was not hindered.

(Evaluation of Adhesive Properties to Back Side of Pressure-Sensitive Adhesive Layer)

The pressure-sensitive adhesive sheet obtained in Preparation Example 1 of Extensible Waterproofing and Airtight Pressure-Sensitive Adhesive Sheet was cut into a width of 25 mm to prepare two specimens. Then, a pressure-sensitive adhesive layer of one of the specimens was stuck onto the surface of a substrate of the other specimen (the side of a film layer made of the film forming composition obtained in Preparation Example 1 of Film Forming Composition) by reciprocating a 2-kg roll one time and allowed to stand for a predetermined period of time (30 minutes and 24 hours. A 180°-peel adhesive strength (width of specimen: 25 mm, drawing rate: 300 mm/min, temperature: 23±2° C., humidity: 50±5% RH; the specimen in the side in which the back side of the substrate was stuck to the pressure-sensitive adhesive layer was peeled off) was measured using a tensile tester (a trade name of device: “Autograph” manufactured by Shimadzu Corporation). As a result, the 180°-peel adhesive strength (drawing rate: 300 mm/min) after 30 minutes of standing was 9 N/25 mm, and the 180°-peel adhesive strength (drawing rate: 300 mm/min) after 24 hours of standing was 13 N/25 mm.

(Evaluation of Waterproofing Properties)

The pressure-sensitive adhesive sheet obtained in Preparation Example 1 of Extensible Waterproofing and Airtight Pressure-Sensitive Adhesive Sheet was cut into a width of 100 mm to prepare two specimens. Thereafter, a pressure-sensitive adhesive layer of one of the specimens was overlaid on the surface of a substrate of the other specimen (the side of a film layer made of the film forming composition obtained in Preparation Example 1 of Film Forming Composition) in a length of 25 mm as shown in FIG. 12 and stuck by reciprocating a 2-kg roll one time. Thereafter, a cylinder having a diameter of 70 mm was stood on the overlap, and a boundary thereof with the pressure-sensitive adhesive sheet was subjected to a leak-prevention treatment with a sealing material. Thereafter, water was poured in the cylinder in a height of 50 mm, and after elapsing for 24 hours, the presence or absence of water leakage in the overlap was visually observed. As a result, the water leakage was not found so that waterproofing properties and airtightness were confirmed to be good.

FIG. 12 is a schematic view to show a method of evaluating waterproofing properties in the evaluation of waterproofing properties in the Examples. In FIG. 12, 10a denotes a one-sided specimen (width: 100 mm); 10b denotes the other-sided specimen (width: 100 mm); 10c denotes a cylinder (external diameter: 70 mm, made of a plastic); and 10d denotes water. In FIG. 12, a pressure-sensitive adhesive layer in the one-sided specimen 10a is overlaid and adhered on the surface of a substrate in the other-sided specimen 10b in an overlap length of 25 mm; the cylinder 10c is stood on the above overlap; a boundary between the cylinder 10c and the specimens (10a, 10b) is subjected to a leak-prevention treatment with a sealing material; and water 10d is then poured in the cylinder 10c to a height of 50 mm.

### EXAMPLE 1

The extensible waterproofing and airtight pressure-sensitive adhesive sheet prepared by Preparation Example 1 of Extensible Waterproofing and Airtight Pressure-Sensitive Adhesive Sheet was cut into a width of 100 mm and a length of 100 mm to prepare an sticking specimen of the extensible waterproofing and airtight pressure-sensitive adhesive sheet. The sticking specimen was stuck to a peripheral part of three-plane crossing (a site including a point corner part which comes into contact with three planes and peripheral parts thereof) in a three-plane crossing structure having the three planes wherein the three planes come into contact and respective planes of the three planes also come into contact with each other and all the angles between respective planes are about 90°, under conditions of a temperature of 23±2° C. and a humidity of 50±5% RH as shown in FIGS. 1A, 1B, 1C, 2, 3, 4 and 5.

Specifically, as shown in FIGS. 1A, 1B and 1C, the above sticking specimen was folded in a form that its back side (i.e., the side at the film layer) is positioned each other in an opposed manner toward the inner side and the pressure-sensitive adhesive surface is positioned toward the outer side so as to form a twofold state and subsequently the resulting sheet was folded in a form that one pressure-sensitive adhesive surface at the outer side in a protected state with the release liner was positioned in an opposed manner toward the inner side and another pressure-sensitive adhesive surface at the outer side was positioned toward the outer side so as to form a fourfold state. Thereafter, as shown in FIG. 2, the release liner which protects the pressure-sensitive adhesive surface positioned at the outer side in the case that the sheet was folded so as to form a fourfold state was peeled off to expose an pressure-sensitive adhesive surface.

Then, the pressure-sensitive adhesive surface exposed at the outer side in the extensible waterproofing and airtight pressure-sensitive adhesive sheet folded so as to form a fourfold state was closely stuck to any two planes in a three-plane crossing structure having three planes wherein the three planes come into contact and respective planes of the three planes also come into contact with each other, as shown in FIG. 3. Specifically, the extensible waterproofing and airtight pressure-sensitive adhesive sheet was stuck to two planes which form a linear corner part, to which a linear folded part folded so as to form a fourfold state is coincident or almost coincident, in the peripheral parts of three-plane crossing of the three-plane crossing structure, in a form that a twice-folded point edge part at which a linear folded part at the time when the sheet is folded so as to form a twofold state and a linear folded part at the time when the sheet is folded so as to form a fourfold state cross each other is coincident or almost coincident to the point corner part which comes into contact with the three planes in a three-plane crossing structure as well as the linear folded part at the time when the sheet is folded so as to form a fourfold state is coincident or almost coincident to the linear corner part at which any two planes come into contact with each other in the three-plane crossing structure and the linear folded part at the time when the sheet is folded so as to form a twofold state is coincident or almost coincident to the other two liner corner parts in the three-plane crossing structure.

Subsequently, from the extensible waterproofing and airtight pressure-sensitive adhesive sheet stuck to the predetermined two plane in the three-plane crossing structure in the predetermined form, as shown in FIG. 4, the release liner which protects the pressure-sensitive adhesive surface in an unstuck state was peeled off to expose the remaining pressure-sensitive adhesive surface in a state protected with the release liner. Thereafter, the pressure-sensitive adhesive surface was closely stuck to the other one plane in the three-plane crossing structure with extending the surface from the two linear corner parts in the three-plane crossing structure, to which the linear folded part at the time when the sheet is folded so as to form a twofold state was coincident or almost coincident, to the direction of unstuck one plane in the three-plane crossing structure, whereby the extensible waterproofing and airtight pressure-sensitive adhesive sheet was closely stuck to the peripheral part of three-plane crossing including the point corner part which came into contact with three planes and peripheral parts thereof, as shown in FIG. 5.

After the extensible waterproofing and airtight pressure-sensitive adhesive sheet was stuck to the peripheral part of three-plane crossing in the three-plane crossing structure, the sheet was allowed to stand under conditions of a temperature of 23±2° C. and a humidity of 50±5% RH for 24 hours. Thereafter, when the appearance of the extensible waterproofing and airtight pressure-sensitive adhesive sheet was visually observed, the presence or absence of peeling or lifting of the pressure-sensitive adhesive sheet, which likely hinders waterproofing properties and airtightness, was confirmed, and sticking application properties were evaluated, no peeling nor lifting was observed.

Therefore, according to the waterproofing execution method of a three-plane crossing structure by Example 1, even at a peripheral part of three-plane crossing including a point corner part which comes into contact with three planes and peripheral parts thereof, a waterproofing and airtight pressure-sensitive adhesive sheet can be stuck efficiently and easily and thus waterproofing execution can be applied with excellent waterproofing properties and airtightness.

While the invention has been described in detail and with reference to specific embodiments thereof, it will be apparent to one skilled in the art that various changes and modifications can be made therein without departing from the spirit and scope thereof.

What is claimed is:

1. A waterproofing execution method of a three-plane crossing structure by means of an extensible waterproofing and airtight pressure-sensitive adhesive sheet comprising sticking the extensible waterproofing and airtight pressure-sensitive adhesive sheet to a peripheral part of three-plane crossing including a point corner part which comes into contact with three planes in a three-plane crossing structure having the three planes wherein the three planes come into contact and respective planes of the three planes also come into contact with each other and peripheral parts thereof, which comprises the following processes (A) to (E);
(A): a step of folding the extensible waterproofing and airtight pressure-sensitive adhesive sheet having a form that a pressure-sensitive adhesive layer protected with a release liner is formed on one surface of a substrate in a form that its back side is positioned each other in an opposed manner toward the inner side and the pressure-sensitive adhesive surface is positioned toward the outer side so as to form a twofold state and subsequently folding the resulting sheet in a form that one pressure-sensitive adhesive surface at the outer side in a protected state with the release liner is positioned in an opposed manner toward the inner side and another pressure-sensitive adhesive surface at the outer side is positioned toward the outer side so as to form a fourfold state;
(B): a step of peeling off the release liner which protects the pressure-sensitive adhesive surface positioned at the outer side in the case that the sheet may be folded so as to form a fourfold state, at any of a stage before it is folded so as to form a twofold state, a stage after it is folded so as to form a twofold state and before it is folded so as to form a fourfold state, and a stage after it is folded so as to form a fourfold state in the step (A);
(C): a step of closely sticking the pressure-sensitive adhesive surface exposed at the outer side in the extensible waterproofing and airtight pressure-sensitive adhesive sheet folded so as to form a fourfold state to two planes which form a linear corner part, to which a linear folded part folded so as to form a fourfold state is coincident or almost coincident, in the peripheral parts of three-plane crossing of the three-plane crossing structure, in a form that a twice-folded point edge part at which a linear folded part at the time when the sheet is folded so as to form a twofold state and a linear folded part at the time when the sheet is folded so as to form a fourfold state cross each other is coincident or almost coincident to the point corner part which comes into contact with the three planes in a three-plane crossing structure as well as the linear folded part at the time when the sheet is folded so as to form a fourfold state is coincident or almost coincident to the linear corner part at which any two planes come into contact with each other in the three-plane crossing structure and the linear folded part at the time when the sheet is folded so as to form a twofold state is coincident or almost coincident to the other two liner corner parts in the three-plane crossing structure, after the steps (A) and (B);
(D): a step of peeling off the release liner which protects the pressure-sensitive adhesive surface in an unstuck state in the extensible waterproofing and airtight pressure-sensitive adhesive sheet, after the step (C); and
(E): a step of closely sticking the pressure-sensitive adhesive surface exposed in an unstuck state in the extensible waterproofing and airtight pressure-sensitive adhesive sheet to the other one plane in the peripheral part of three-plane crossing of the three-plane crossing structure with extending the surface from the other two linear corner parts in the peripheral part of three-plane crossing of the three-plane crossing structure to the direction of the other one plane, after the step (D).

2. The waterproofing execution method of a three-plane crossing structure by means of an extensible waterproofing and airtight pressure-sensitive adhesive sheet according to claim 1, wherein the three-plane crossing structure is any of (1) a three-plane crossing structure having three planes wherein the three planes come into contact and respective planes of the three planes come into contact with each other as well as all of the angles between respective planes are less than 180°, (2) a three-plane crossing structure having three planes wherein the three planes come into contact and respective planes of the three planes come into contact with each other as well as two of the angles between respective planes are less than 180° and one of the angles exceeds 180°, (3) a three-plane crossing structure having three planes wherein the three planes come into contact and respective planes of the three planes come into contact with each other as well as one of the angles between respective planes is less than 180° and two of the angles exceed 180°, or (4) a three-plane crossing structure having three planes wherein the three planes come into contact and respective planes of the three planes come into contact with each other as well as all of the angles between respective planes exceed 1800.

3. The waterproofing execution method of a three-plane crossing structure by means of an extensible waterproofing and airtight pressure-sensitive adhesive sheet according to claim 1, wherein the extensible waterproofing and airtight pressure-sensitive adhesive sheet is provided with split in the back at a site of the release liner corresponding to the linear folded part at the time when the sheet is folded into two, so as to be able to peel off the release liner which protects the pressure-sensitive adhesive surface positioned toward the outer side at the time when the sheet is folded so as to form a fourfold state.

4. The waterproofing execution method of a three-plane crossing structure by means of an extensible waterproofing and airtight pressure-sensitive adhesive sheet according to any one of claims 1 to 3, wherein the extensible waterproofing and airtight pressure-sensitive adhesive sheet has an elongation at break (distance between two gauge marks: 40 mm, drawing rate: 300 mm/min) of 200 to 1200% in both the longitudinal direction and the cross direction and a stress under 100% elongation (distance between two gauge marks: 40 mm, drawing rate: 50 mm/min) of 10 to 100 N/cm² in both the longitudinal direction and the cross direction.

5. The waterproofing execution method of a three-plane crossing structure by means of an extensible waterproofing and airtight pressure-sensitive adhesive sheet according to claim 4, wherein the extensible waterproofing and airtight pressure-sensitive adhesive sheet comprises a rubber-made sheet as a substrate and a film layer having non-self-adhesive properties and pressure-sensitive adhesive layer-adhesive properties is formed on the surface opposite to the pressure-sensitive adhesive layer of the substrate.

6. The waterproofing execution method of a three-plane crossing structure by means of an extensible waterproofing and airtight pressure-sensitive adhesive sheet according to claim 5, wherein the rubber-made sheet comprises a rubber composition containing a synthetic rubber as a main component.

7. The waterproofing execution method of a three-plane crossing structure by means of an extensible waterproofing and airtight pressure-sensitive adhesive sheet according to claim 6, wherein the synthetic rubber of the rubber-made sheet is at least one synthetic rubber selected from a butyl rubber, an ethylene-propylene rubber, and an ethylene-propylene-diene rubber.

8. The waterproofing execution method of a three-plane crossing structure by means of an extensible waterproofing and airtight pressure-sensitive adhesive sheet according to claim 5, wherein the film layer having non-self-adhesive properties and pressure-sensitive adhesive layer-adhesive properties is formed with a film-forming composition containing an acrylic polymer or a long-chain alkyl compound.
